(19) United States
(12) Patent Application Publication
(10) Pub. No.: US 2022/0366507 A1
(43) Pub. Date: Nov. 17, 2022

(54) Home Health Optimization via Connected Providers

(71) Applicant: Shipshape Solutions, Inc., Austin, TX (US)

(72) Inventor: Alexander Saunders Linn, Dallas, TX (US)

(73) Assignee: Shipshape Solutions, Inc., Austin, TX (US)

(21) Appl. No.: 17/816,416

(22) Filed: Jul. 31, 2022

Related U.S. Application Data
(63) Continuation-in-part of application No. 17/215,955, filed on Mar. 29, 2021.
(60) Provisional application No. 63/003,725, filed on Apr. 1, 2020.

(51) Int. Cl. G06Q 40/08; G06Q 50/16

(52) U.S. Cl. CPC G06Q 40/08; G06Q 50/163

(57) ABSTRACT

The present invention comprises a novel Virtual Facilities Manager architecture that optimizes home health by combining multiple prediction engines, fed by continuously monitored and processed sensor-based and environmental data (historical as well as current), with an integrated Homecare Network of homeowners and service and other providers. This enables a continuous feedback process in which abnormal conditions (symptoms of an underlying problem, including suboptimal performance, as well as systemic scores exceeding predefined thresholds) are detected and addressed by issuing contextual alerts with associated actions (related alert-action pairs) in an iterative manner over time. By maintaining a Home Health Record including Scores (e.g., reliability and energy efficiency) representing the systemic state of one or more homes, the present invention enables connected providers to offer personalized provider services to targeted subsets of existing and prospective customers.

### CROSS-REFERENCE TO RELATED APPLICATIONS

This application claims priority to U.S. patent application Ser. No. 17/215,955, filed Mar. 29, 2021 and entitled “Home Health Optimization,” which claims priority to U.S. provisional patent application Ser. No. 63/003,725, filed Apr. 1, 2020 and entitled “Virtual Maintenance,” the disclosure of which is hereby incorporated by reference as if fully set forth herein.

### BACKGROUND

### Field of Art

The present invention relates generally to the automated optimization of the health of residential and commercial infrastructure, and more particularly to sensor-based systems that quantify dynamic changes to the systemic health of one or more properties, diagnose abnormal conditions, continuously calculate systemic scores and associated explanatory actionable context, and offer personalized provider services to targeted subsets of homeowners.

### Description of Related Art

The long-term maintenance of equipment and other infrastructure on the premises of virtually any home or business is a well-known problem that has received relatively little attention over the years. Even less frequently addressed is the systemic performance of a residence or neighborhood and its component equipment systems and infrastructure.

For example, higher-level concepts such as reliability and energy efficiency are routinely considered during the planning and construction of a building. But such concepts are rarely if ever monitored and optimized as conditions change over time after the buildings are occupied. Moreover, while one can quantify such concepts with respect to individual equipment, it is much more difficult to do so at a more systemic level involving equipment systems or an entire household or neighborhood.

While much of the following discussion relates to residential infrastructure (such as HVAC, water control, pool and solar systems, as well as plumbing, electrical, crawl spaces, etc.), the problems and solutions set forth below apply equally to infrastructure and industrial equipment in commercial businesses, government entities and other small, medium and large enterprises.

Homeowners, for example, typically treat their home's infrastructure as silos of expensive items of equipment (refrigerators, freezers, AC units, furnaces, boilers, sump pumps, dehumidifiers, pool pumps, solar panels, etc.) that operate over relatively long periods of time and require only occasional repair and (only if necessary) eventual replacement. Homeowners often are unaware of problems before conspicuous symptoms arise, are uncertain of which provider can best address such symptoms, and are hesitant to incur the expense of calling service technicians unless and until significant problems are evident.

Moreover, homeowners often do not maintain such equipment as frequently as recommended. When they do eventually call service technicians, problems are often more severe and require relatively expensive repairs. As a result of such “reactive” maintenance, the life of such equipment is often shorter, while its cost of ownership is higher and its operation over time is less efficient than if such equipment had been maintained in a proactive and more effective manner.

It should be noted that the term “maintenance” is used herein to address an array of different types of problems that occur with respect to a property's equipment and other infrastructure. For example, particular equipment may be in need of “repair” because one or more of its components are broken and need to be fixed. Or “preemptive maintenance” may be recommended to avoid a future repair, thereby enhancing reliability and reducing overall costs. Or the “operational performance” of particular equipment may fail to satisfy a homeowner's desired level of efficiency or comfort, or may simply be suboptimal, potentially indicating an emerging risk.

Moreover, any of these and other related types of problems may be systemic in that they are not isolated to a single piece of equipment, and may involve systems of equipment or even whole-home or multi-home issues. The interdependence among the equipment and infrastructure of a home only exacerbates the difficulty of troubleshooting certain problems. Such systemic problems may require systemic solutions, such as adding, upgrading or replacing particular equipment, modifying device settings or otherwise altering a home's infrastructure.

As “smart homes” and the “Internet of Things” (“IoT”) have proliferated, so too has the ability to monitor device operation and detect abnormal conditions—particularly with the application of machine learning and other forms of artificial intelligence (“AI”). Yet the primary focus of these smart systems has been on the control and interoperability of connected devices, rather than on the detection of abnormal conditions and the extensive troubleshooting expertise necessary to resolve many such conditions.

Some existing smart home systems monitor device characteristics that change over time and generate automated alerts or notifications when an abnormal condition or actionable event is detected. For example, a system from Alert Labs (described in published US patent applications 2018/0365957 and 2018/0375680) employs water, temperature, electrical and other sensors to monitor characteristics of particular equipment (HVAC systems, sump pumps, etc.) and the general environment within the home. It further includes an analytics engine (e.g., employing machine learning) to analyze the sensor data for the purpose of detecting abnormal conditions and issuing alerts to notify homeowners.

But, not unlike the satirical “dental monitor” television commercials in which a patient is diagnosed with a dental problem (e.g., a cavity) yet is sent home without the problem being fixed, these systems offer little in the way of resolving abnormal conditions beyond providing an alert or notification of the condition. While there is certainly significant benefit to early detection of minor as well as urgent problems, homeowners are left to their own devices to troubleshoot and address such problems. As a result, they will still likely adopt a “reactive” approach, whether they frequently call service technicians or procrastinate due to cost concerns.

Other systems go a step beyond merely monitoring devices and providing alerts indicating the existence of abnormal conditions. For example, a system from Google (described in U.S. Pat. No. 10,423,135) monitors the activities of occupants as well as the operation of devices in the home. In response to detecting that certain specified conditions within predefined user policies are satisfied, it implements such user policies by adjusting the configuration or operation of various devices (such as locking or unlocking doors, turning specified lights on or off, adjusting the temperature settings of thermostats to increase energy efficiency, etc.).

While allowing for user input and goal-based device control is beneficial, it does not address the problem of detecting abnormal conditions (as opposed to detecting conditions that merely satisfy a predefined user policy). Even more importantly, it does not address the difficult task of iteratively troubleshooting and addressing such abnormal conditions over time. In other words, the Google system does not suggest how it could detect an abnormal condition such as a faulty component of an HVAC system or pool pump, much less how it would troubleshoot such a problem.

Still other systems, such as one from Powerhouse Dynamics (described in U.S. Pat. No. 8,649,987), have taken a narrower approach to monitoring the performance of individual appliances (e.g., on dedicated circuit breakers). The Powerhouse Dynamics system measures an appliance's electrical consumption over time and compares its performance to that of other appliances stored in the system's database (e.g., appliances of the same model, as well as other comparable appliances, such as newer and more energy-efficient ones).

Upon detecting a significant variance in the performance of the appliance as compared to that of other appliances in its database (such as irregular or particularly inefficient electrical usage), the system not only issues an alert to notify the user, but also includes a recommendation from its “recommendation database.” Such recommendations include information on cost/energy savings of other comparable appliances, as well as appliance diagnostics and manufacturer-recommended remedial or corrective actions (such as turning an appliance or its circuit on or off).

While the inclusion of such additional recommendations is useful, this system still falls far short of providing actions that are tantamount to the iterative series of steps that users and service providers would perform over time to troubleshoot and address underlying problems, as opposed to the symptoms corresponding to the alert. Moreover, the Powerhouse Dynamics system is limited not only to monitoring electrical consumption, but to monitoring the performance characteristics of an individual appliance (as opposed to taking a systemic approach to detecting and resolving abnormal conditions). In other words, it fails to obtain (and therefore cannot utilize in its recommendations) a “contextual awareness” of the home's operation over time.

As alluded to above, abnormal conditions cover a wide gamut of potential problems, many of which are extremely difficult to troubleshoot, even for a professional service provider. Only the most trivial of such problems is likely to be resolved by a manufacturer-supplied recommended step or procedure (even assuming the problem is confined to that single appliance).

Moreover, it is inefficient for homeowners to choose between calling a service technician whenever the slightest symptom appears (assuming the homeowner is even aware of who to call), or to wait until severe symptoms arise. There is clearly a need for a system that performs iterative troubleshooting on a recurring basis over time, and offloads a significant portion of this complex task from homeowners and providers.

Many complex problems require that steps be taken over time, with subsequent steps dependent on the results of prior ones, as well as on changes that may only be reflected by monitoring sensor-based and environmental data. Subsequent symptoms may differ, but still be related to one another (and to one or more underlying problems) over time, and may even involve multiple appliances or other infrastructure in the home.

In an ideal world, one would have access to a free professional facilities manager onsite on a 24/7 basis, who needed no sleep and had a perfect memory of all (current and historical) local sensor and external environmental data, as well as performance models of all equipment and other infrastructure that are or could be installed in the home (not to mention the ability to detect suboptimal performance with respect to higher-level concepts such as energy efficiency throughout the home).

Such an ideal “virtual facilities manager” would detect, anticipate and address all such problems in a systemic manner that aligns the goals of homeowners and various service and other providers, and thus reveals the many shortcomings in these existing systems, including additional cost due to a reactive maintenance approach, lower efficiency of equipment operation over time and an inability to detect and resolve systemic problems affecting multiple items of equipment and infrastructure, among others.

In short, there remains a need for a system that not only can monitor (on a continuous basis) sensor-based and external environmental data relating to the operation of equipment and other infrastructure in the home, and detect abnormal conditions over time (from a systemic as well as individual device perspective), but also can address such abnormal conditions by issuing contextual alerts and simulating the iterative troubleshooting steps (with the integral involvement of homeowners and providers) that a theoretical virtual facilities manager would perform over time.

Such a system would, in effect, go well beyond a “check engine light for the home,” in that it would eliminate the need for many expensive service calls and, when certain service calls were necessary, would provide service providers with a valuable “head start” in the troubleshooting process. Service providers would also benefit not only from the leads they can obtain via such an automated system, and from the ability to handle a greater quantity of less complex service calls, but also from the interactive relationships they can develop and maintain with customers via such an integrated system.

Moreover, such a system would optimize the health of the home (in accordance with an owner's predefined goals) by continuously monitoring and quantifying higher-level systemic health indicators (such as reliability, energy efficiency and maintenance costs), issuing alerts upon detecting suboptimal performance and recommending and facilitating the implementation of iterative troubleshooting steps to address such suboptimal performance.

Another significant impediment to managing the health of homes is the lack of visibility that various providers have into homeowner activity and related dynamic factors over time. As noted above, service providers are generally made aware of issues only after a service call is warranted. For example, an HVAC repair company is typically unaware of the “operational characteristics” of an HVAC system over time. Even an annual maintenance program is often insufficient to detect and resolve problems before they become significant.

Other providers (such as insurance providers) typically inspect homes infrequently—e.g., upon issuance of a new insurance policy when a home is purchased. Apart from possible alarm monitoring, an insurance provider has little or no visibility into the dynamic factors that would affect their assessment of a homeowner's “risk of loss” (“ROL”), based upon “ROL Factors” such as equipment age, usage, maintenance and repairs or replacements over time, among many other factors.

The need for smarter and more personalized insurance-based services has been well documented. See, for example, the following articles from McKinsey & Company (https://www.mckinsey.com/industries/financial-services/our-insights/insurance-2030-the-impact-of-ai-on-the-future-of-insurance?cid=other-eml-shl-mip-mck&hlkid=0decd5ce3087495dbdfd2174c7431e34&hctky=11733752&hdpid=97e8739c-28f0-4029-8c3a-e237926d8029) and American Family Insurance or AMFAM (https://presspage-production-content.s3.amazonaws.com/uploads/1467/smarthomeinsurancewhitepaper2019-222274.pdf?10000).

These articles emphasize the emergence of smart home technology and the potential use of AI to analyze big data. Other insurance companies, such as Hippo (based in Palo Alto, Calif.), have also touted their use of AI and big data to analyze properties. Moreover, State Farm has obtained patents on systems designed to facilitate claims processing and other modifications to a homeowner's existing insurance policy (see, e.g., U.S. Pat. Nos. 10,679,292 and 10,282,788). But what is lacking in all of these systems is an integration of a network of providers, not only for repair and maintenance of equipment, but for insurance, warranty and other services.

What is needed is a system that integrates existing and prospective providers in a manner that offers providers continuous visibility into the dynamic factors that affect their assessment over time of which particular services to provide to which homeowners, and when to provide them. Such a system would enable providers not only to respond to alerts reflecting abnormal conditions, but to offer personalized services proactively to targeted subsets of homeowners selected based on their dynamic need for such services.

Another shortcoming of existing alert-based systems (including those employing smart-home monitory technology, such as Hippo, and those envisioned in the above McKinsey & Company and AMFAM articles) is the lack of “actionable context” associated with an alert. Mere access to alerts is often insufficient to troubleshoot underlying problems, much less prevent them.

Moreover, raw sensor data rarely provides sufficient context to assess alerts. For example, in the context of an insurance-related ROL alert, it may well be unclear which ROL Factors were most responsible for this “systemic alert.” While AI technology may help “make sense of” raw sensor data (e.g., to predict the source of or solution to a problem), AI and related techniques could also be employed to enable the extraction of actionable context from such raw sensor data.

While machine learning has been employed generally to identify actionable variables that have significant effects on outcomes (e.g., Salesforce's U.S. Pat. No. 9,098,810), such techniques have not been employed in the context of systemic alerts for the purpose of facilitating third-party providers in assessing such alerts to provide personalized and targeted responses.

What is needed is an alert-based smart home monitoring system that not only provides systemic alerts, but also supplements such alerts with sufficient context to make them actionable by relevant providers—i.e., to offer personalized services to targeted homeowners based upon such actionable context.

Finally, existing systems lack a logistical mechanism to enable relevant existing and prospective providers to receive systemic alerts, along with actionable context, and to offer personalized provider services to targeted subsets of homeowners. What is needed is an integrated “provider network” that enables such functionality.

### SUMMARY

The present invention addresses the shortcomings of existing systems described above with a novel “Virtual Facilities Manager” architecture that combines multiple prediction engines, fed by continuously monitored and processed sensor-based and environmental data (historical as well as current), with integrated networks of homeowners and service and other providers, such as manufacturers, retailers, installers, insurers, home warranty companies and even institutional home-maintenance providers. The integration of these various components into a Virtual Facilities Manager (“VFM”) system enables a continuous feedback process in which abnormal conditions are detected and addressed by issuing contextual alerts with associated actions in an iterative manner over time, recognizing that many underlying problems can only be addressed effectively via a complex diagnostic and iterative troubleshooting process requiring multiple related actions over time (“related alert-action pairs”).

At a conceptual level, the VFM system optimizes “home health” by employing a proactive and iterative troubleshooting process that detects and addresses a variety of underlying problems as they arise over time. Certain problems involve a single item of equipment, while others are systemic in nature. Whether systemic or otherwise, some problems reflect broken components in need of repair, while others reflect preemptive maintenance issues designed to maintain “healthy” and reliable operation to avoid future repairs, and still others reflect suboptimal operation of the home and its component systems over time (such as a gradual decrease in systemic energy efficiency, not easily remedied, for example, by the replacement or upgrade of one item of equipment).

Contextual alerts take into account the interdependencies among systems of equipment and home infrastructure, as well as external environmental factors. As a result, the VFM system anticipates prospective problems and acts accordingly. In this regard, the VFM system anticipates corresponding systemic solutions—in particular, the next action most likely to resolve the underlying problem of which the current alert is but a symptom. Over time, the solution (a set of related alert-action pairs) may well involve multiple pieces of equipment or other infrastructure throughout the home.

Moreover, by integrating homeowner and provider networks (i.e., into a “Homecare Network”), the VFM system expands its iterative troubleshooting approach to align the goals of homeowners and providers. For example, the VFM system generates actions that are optimized to satisfy specified “User Goals” relating to cost, energy efficiency, reliability and a host of other related factors (alone or in combination) as described below. Such actions also take into account the capabilities of particular occupants—e.g., to perform particular tasks themselves rather than requiring help from an external provider.

In one embodiment, the VFM system also takes into account “Provider Goals” and capabilities. For example, the VFM system may recommend a service provider with specific expertise matching the suspected problem diagnosed via a series of related alert-action pairs. Beyond service providers, the VFM system also assesses the goals as well as the capabilities of other providers (e.g., insurers and home warranty companies) to align such goals with those of particular homeowners (as discussed below).

As will become apparent from the following discussion, the VFM system provides significant advantages to both homeowners and providers. While early-warning alerts are useful to providers as well as to homeowners, they are in the first instance most useful to the VFM system itself, which logs alerts (that may or may not exceed a threshold for informing homeowners or providers) as well as actions in a “Home Health Record” for subsequent use by the VFM system in generating future alerts and corresponding actions.

Certain alerts are handled entirely by the VFM system itself, whether or not the homeowner is notified. For example, the VFM system may reset or “cycle” a device as an initial troubleshooting step to address the abnormal condition that gave rise to the alert. In a subsequent iteration (e.g., after an appropriate period of time has elapsed), the system may or may not generate that same alert, depending upon the extent to which this first troubleshooting step was effective.

In other situations, the VFM system may ask the homeowner to perform that step. For example, one troubleshooting step may include a request to cycle a circuit breaker or check a particular setting or other state of certain equipment. That step may also include a request for feedback. But, in many situations, that first step and any feedback will merely be “input” to subsequent iterations of the VFM system that may or may not eventually result in the same or a related alert.

In this manner, the VFM system generates an iterative sequence of troubleshooting actions over time in an effort to determine the underlying cause of abnormal conditions that gave rise to a set of related alerts and corresponding actions. It is important to emphasize the distinction between this dynamic set of related alert-action pairs (generated iteratively via multiple integrated prediction engines) and a static predetermined manufacturer-supplied procedure (or even a predicted multi-step process).

In one embodiment of the present invention, every subsequent related alert-action pair is dependent upon the one that preceded it, as well as upon the interim changes in the sensor and environmental data. Just as an algorithmic music service only generates a single “next” song at a time, the VFM system typically generates only the “next action” to be performed—because subsequent actions or troubleshooting steps are dependent upon future conditions that typically cannot be predetermined as a practical matter.

As noted above, certain steps are performed entirely by the VFM system, while others are performed by homeowners and may eventually require one or more service calls. Because many problems cannot be addressed adequately without the benefit of time between troubleshooting steps, this process minimizes the need for service calls and makes such service calls, when necessary, far more efficient.

Moreover, the integration of the Homecare Network into the VFM system enables various providers to participate in the troubleshooting process (i.e., “human troubleshooting”) long before service calls may become necessary. In many cases, such participation may delay or even prevent service calls that might otherwise have been inevitable. When a service call is required, the technician benefits from prior troubleshooting efforts, even those from other providers that may not even be in the same geographic area.

It should be noted that the VFM system applies the same iterative troubleshooting approach to the “problem” of suboptimal performance. Even if all equipment is operating as expected, the VFM system may detect that the home's “Energy Efficiency” score has fallen below a predefined threshold. Resolving this underlying problem may require a series of different recommended actions implemented iteratively over time until the score returns to an acceptable level (e.g., recalibrating one or more thermostats, replacing an older less efficient water heater and adding solar panels).

With respect to scenarios in which providers desire to offer personalized provider services to targeted subsets of homeowners, the present invention addresses the shortcomings of existing systems, such as those described above, by integrating the Homecare Network with smart home technology to offer providers visibility into homeowner activity over time. Not only are relevant providers alerted when abnormal conditions arise, but the Homecare Network also allows providers to filter the Home Health Record of homeowners for specified criteria in order to target a desired subset of homeowners with offers of personalized provider services.

The VFM system employs “systemic scoring” to maintain scores reflecting the “systemic state” of a home (or of component systems, equipment or infrastructure). For example, these systemic scores” measure a home's reliability, energy efficiency, ROL and other dynamic attributes that may be of particular interest to certain types of providers. Systemic scores include ROL (eg, Insurers), Comfort Score (eg, Utilities optimizing electrical grid), Liability Score (eg, Manufacturers), Performance Score (eg, Repair Contractors, HVAC Dealers, etc), and Maintenance Score (eg, Warranty Providers), among many others.

As described in greater detail below, each systemic score (e.g., ROL) is essentially a function of multiple factors (e.g., ROL Factors). While the VFM system provides a default function for each systemic score, providers may customize this function (e.g., by adding or removing factors, modifying the weighting of factors or even substituting the provider's own private or published function). The VFM system continuously monitors these factors to maintain current system scores.

When a systemic score exceeds a predefined threshold, the VFM system triggers a systemic alert reflecting an abnormal condition. Upon determining a relevant subset of providers to whom this systemic alert is relevant, the VFM system notifies such providers via the Homecare Network. It should be noted that the Homecare Network connects providers not only with their existing customers, but with prospective customers as well. In this manner, homeowners may receive services and related benefits from providers beyond their physical service area.

In addition to notifying providers of each relevant systemic alert, the VFM system also generates corresponding actionable context to enable providers to make a meaningful assessment of systemic alerts over time. This context makes systemic alerts “actionable” by enabling providers to respond with offers of personalized provider services.

In one embodiment, actionable context includes the “key factors” that most contributed to the systemic score exceeding the predefined threshold. Note that the key factors will not necessarily be the most heavily weighted factors, as those may or may not be the ones to which the change in a systemic score is most attributable.

It should be noted that the Homecare Network is a two-way network, in which the VFM system communicates systemic alerts and associated actionable context to providers (among other information), while providers communicate offers of personalized provider services to targeted subsets of homeowners (existing and prospective customers). Such offers may be in response to systemic alerts, or initiated by providers (e.g., after filtering the Home Health Record of a subset of homeowners for specified targeting criteria).

In this manner, provides effectively “select their customers” as well as incentivize customers to improve their systemic scores. Providers can better service existing customers by offering personalized incentives that reflect such providers' visibility into such customers' activity over time. Providers can also attract new “desired” customers with offers of targeted incentives that also reflect such providers' visibility into those prospective customers' activity over time.

The following description will illustrate the architecture and key components of the present invention, as well as the dynamic processes that the VFM system performs over time.

### BRIEF DESCRIPTION OF THE DRAWINGS

FIG. 1 is a system diagram illustrating an embodiment of the key components of the present invention.

FIG. 2 is a flowchart illustrating an embodiment of the key steps of a dynamic process by which the present invention maintains the health of the equipment and infrastructure of one or more properties.

FIG. 3A is an architectural diagram illustrating an embodiment of a neural network implementation of a scoring engine of the present invention, including key inputs and outputs.

FIG. 3B is an architectural diagram illustrating an embodiment of a neural network implementation of an alert generation engine of the present invention, including key inputs and outputs.

FIG. 3C is an architectural diagram illustrating an embodiment of a neural network implementation of an action and goals optimization engine of the present invention, including key inputs and outputs.

FIG. 4A is a flowchart illustrating an embodiment of the key steps of a dynamic process by which the present invention enables connected providers to offer personalized provider services to targeted subsets of existing and prospective customers in response to systemic alerts.

FIG. 4B is a flowchart illustrating an embodiment of the key steps of a dynamic process by which the present invention enables connected providers to offer personalized provider services to targeted subsets of existing and prospective customers determined as a result of proactive provider-initiated filtered searches of homeowner Home Health Records.

### DETAILED DESCRIPTION

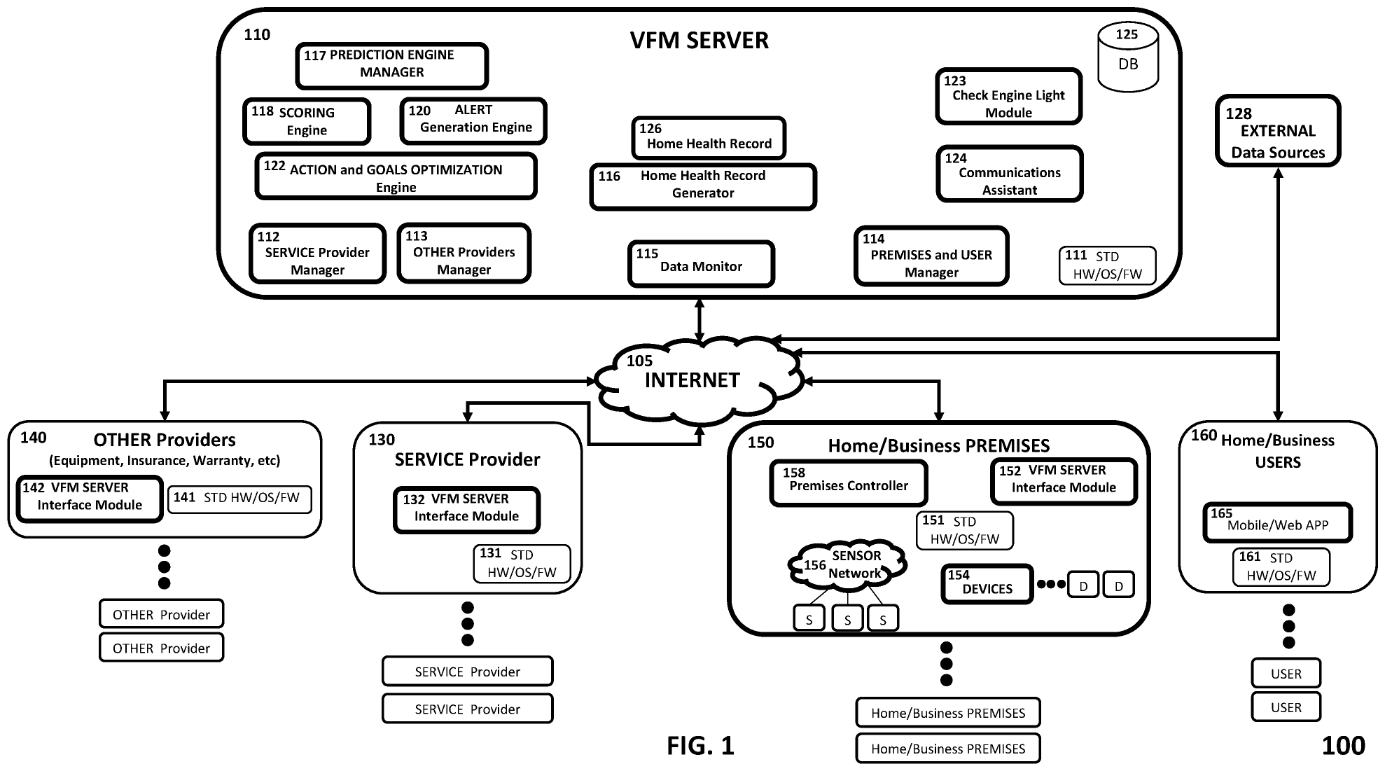

Turning to FIG. 1, the primary functionality of the VFM system 100 is embodied in a VFM Server 110 that communicates over the Internet 105 with integrated networks of (i) providers, including Service Providers 130 and Other Providers 140 (eg, equipment vendors, insurance and warranty providers, etc.) and (ii) users (including homeowners, business owners and other users) from their desktop, laptop and mobile devices 160 and from their Home and Business Premises 150. The VFM system 100 also integrates with External Data Sources 128, for example, to obtain environmental data, such as weather data, as well as air, water and soil quality data and event data (eg, regarding recent earthquakes, floods or disease outbreaks).

VFM Server 110 can be implemented as a single physical server device, as illustrated in FIG. 1 (including standard hardware, firmware and operating system 111), or as multiple interconnected servers (e.g., via Internet 105). Such server functionality can also be implemented, in other embodiments, across one or more physical devices, and by distributing the functionality of modules illustrated in FIG. 1 into a fewer or greater number of modules (including different allocations of hardware and software functionality).

VFM Server 110 further includes Data Monitor 115 (explained in greater detail below) to collect and process data from premises (e.g., sensor data), providers and other external sources, such as External Data Sources 128. Such data (both current and historical) are fed into prediction engines to detect abnormal conditions, generate alerts and corresponding actions on an iterative basis over time.

VFM Server 110 employs Prediction Engine Manager 117 to manage a set of prediction engines to generate alerts and corresponding actions, as described in greater detail below. In one embodiment, these prediction engines include Scoring Engine 118 (to manage scores and subscores representing systemic states of an individual premises, as well as component systems, equipment and infrastructure), Alert Generation Engine 120 (to generate alerts reflecting the occurrence of abnormal conditions) and Action and Goals Optimization Engine 122 (to generate actions corresponding to such alerts in a manner that optimizes user-specified goals).

Once VFM Server 110 generates an alert and corresponding action, a Communications Assistant (i.e., a “Home Assistant”) 124 manages the process of communicating alert-action pairs (and related metadata and other summarized historical data from Home Health Record 126—in one embodiment stored in Database 125) to homeowners and/or providers, as discussed below. For example, in one embodiment, Communications Assistant 124 follows up with homeowners to determine whether particular actions were implemented (e.g., changing an air filter). Such information is then updated in the homeowner's Home Health Record 126, and may even be utilized, for example, by providers (service providers, insurance providers, warranty providers, etc.) to offer “credits” for such home maintenance tasks.

While Communications Assistant 124 manages communications to and from VFM Server 110, Check Engine Light Module 123 includes a set of APIs (and corresponding SDKs) that facilitate the creation of third-party applications (such as smartphone apps, or applications on desktop and laptop computers) which integrate and extend the functionality of VFM system 100.

Premises and User Manager 114 manages the common and unique characteristics of various homeowners (and owners of businesses and other types of enterprises) across the Homecare Network. This includes managing the process of acquiring information about the various premises and their owners across the Homecare Network, and leveraging such information to create and manage specific tasks unique to particular premises and/or their owners (as well as other users) via their desktop or laptop computers or mobile devices 160.

In addition to interacting with homeowners, Communications Assistant 124 (with the assistance of various “provider manager” modules) also facilitates interactions with providers in accordance with preconfigured protocols. For example, when a service call is deemed necessary, Communications Assistant 124 and Service Provider Manager 112 (along with Other Providers Manager 113) together manage the process of automatically providing relevant summary data (current alert-action pair, relevant service history, etc.) to specified service providers via the Homecare Network. In one embodiment, service providers are involved even before a service call is deemed necessary, enabling additional troubleshooting input by service providers, which reduces the likelihood of an eventual service call.

As a result, homeowners reduce their out-of-pocket expenses for service calls over time, as well as benefit from increased efficiency and reliability due not only to the early detection of abnormal conditions, but to the corresponding troubleshooting actions designed to address those conditions over time. In short, homeowners experience greater energy efficiency, reliability, safety and extended life of their equipment and other infrastructure.

Moreover, from an operational standpoint, VFM system 100 reduces the overall cost and operational efficiency of the home infrastructure on a systemic basis. For example, VFM Server 110 generates alerts that are not necessarily restricted to an individual item of equipment, but may relate to the performance of a system of equipment (e.g., an HVAC system) that includes multiple items of equipment and infrastructure (e.g., an AC unit, condensate pump, furnace or boiler, ducts, dampers, thermostats, etc.). Corresponding actions may include troubleshooting steps with respect to multiple pieces of equipment and other infrastructure (and components thereof) within that system (or in some cases even outside of a particular system).

Service providers also benefit from this VFM architecture in that they become part of the integrated Homecare Network. For example, service providers in a homeowner's geographic area receive automated leads to many homeowners in that area. By leveraging the opportunity to participate in the troubleshooting process (e.g., receiving detailed relevant data and providing troubleshooting input even before a service call is required), service providers can increase their chances of turning such leads into actual business (as well as be incentivized in other ways to encourage their participation from geographically distant areas).

Moreover, their cost of each “truck roll” can be reduced significantly by virtue of receiving detailed relevant service history in advance of a service call. Many service calls can be avoided, and those that are necessary are more efficient as a result of the service provider's contextual awareness of the recent and historical performance of systems of equipment (even beyond a “suspect” individual item of equipment).

The Homecare Network of VFM system 100 also integrates other types of providers beyond service providers, and aligns their goals with those of particular homeowners. For example, networks of manufacturers, retailers and installers are integrated in a manner that enables the need for new equipment to be interpreted (with the homeowner's permission) as an opportunity to market, sell and install a particular model of equipment.

Such need may be evident, for example, from a recommended alert-action pair, or simply by virtue of the age of the equipment or its performance characteristics over time, alone or in conjunction with a larger system within the home. Homeowners may reach out directly to such integrated providers via the Homecare Network. And the providers may find that their marketing efforts are far more targeted, and thus more effective, in light of their detailed knowledge of the home infrastructure and equipment performance.

An integrated network of warranty providers may, for example, enable a warranty holder (with respect to one or more items of a homeowner's existent equipment) to recommend particular actions for the purpose of avoiding a future warranty claim. Such a company might also offer to renegotiate terms or offer discounts on an extended warranty (e.g., based upon knowledge of a homeowner's diligent maintenance practices and historical operational performance).

Other warranty companies not currently affiliated with the homeowner may (based on current and historical performance data regarding the homeowner's equipment and infrastructure) market new or replacement warranties to the homeowner. In this manner, both the warranty companies and the homeowner benefit from a competitive market that is far more targeted to homeowners “in need” but not necessarily “in distress.”

Similarly, VFM system 100 integrates a network of insurance companies (with or without an existing relationship to the homeowner) that can leverage this targeted knowledge about homeowners' equipment and infrastructure to offer competitive policy rates (including group rates across other homes within the network). Homeowners can also leverage their “preemptive maintenance” history to shop around for more competitive rates directly from insurance companies with an intimate knowledge of certain risks associated with their home's infrastructure.

One particularly valuable provider network includes multi-residence institutional owners who desire to reduce the costs of maintaining the equipment and infrastructure across their various properties. Instead of relying on manually managing multiple property managers across various geographic locations, such institutional providers can instead leverage the “networked property management” features of VFM system 100 via the Homecare Network.

Moreover, these institutional owners can leverage their “volume” purchasing and maintenance power with respect to equipment and infrastructure across such properties to offer their homeowners significant savings and convenience. Not only will homeowners benefit, but service (and other) providers will also benefit from access to these large multi-residence markets.

Such efforts may ultimately move the market further in the direction of an “Equipment-as-a-Service” (“EaaS”) model, in which homeowners lease some or all of their equipment and infrastructure for a monthly (possibly consumption-based) fee that includes service, upgrades and replacement costs, as well as valuable premium discounts on certain items. Under this model, homeowners enjoy the benefits of regular “home maintenance” payments, while avoiding concerns about expensive unexpected and intermittent repair and replacement costs. Yet institutional owners will still have incentives to proactively maintain the equipment and infrastructure across their properties, as such proactive maintenance will reduce their costs over time.

It will be apparent to those skilled in the art that a variety of other integrated provider networks will provide similar benefits (as compared to the Homecare Network) to homeowners and providers alike. In each instance, the integrated providers benefit from access to a very targeted market of homeowners based on the detailed current and historical service and related data provided by VFM system 100. Homeowners similarly benefit from the reduced costs afforded by a “volume purchase” environment, in addition to the convenience and access to targeted experts that are “up to speed” with the state of their home equipment and infrastructure. In short, the Homecare Network of VFM system 100 provides an integrated mechanism to align the goals of homeowners with those of various provider networks.

In one embodiment, Home Health Record 126 includes static as well as dynamic information. For example, it contains the home's geographic location and identification of installed equipment and infrastructure, including its location (e.g., room or more precise position) within the home. It also includes user profile information, such as an occupant's ability and/or desire to perform certain troubleshooting tasks themselves.

The Home Health Record 126 further includes operational models, performance characteristics and specifications (in certain cases specific to the home's geographic location and environment) for each installed item of equipment, as well as for comparable units, such as those that are newer and more energy-efficient and others that may be smaller or larger alternatives from a systemic perspective. In one embodiment, Home Health Record 126 includes information regarding home infrastructure that is not specific to any item of equipment, such as the thermal rating of windows.

Dynamic information includes the age of each item of equipment, warranty information and service history (including identification of service providers). Moreover, the dynamic history of the home includes metadata relating to prior alerts and actions, as well as timestamped raw and/or processed sensor and external environmental data.

In one embodiment (discussed below), Home Health Record 126 also includes scores reflecting the systemic state of the home itself (as well as sub-scores reflecting equipment systems and individual units or devices). For example, a Reliability score might reflect an overall current state of the reliability of the home (taking into account the reliability over time of individual pieces of equipment). In this embodiment, trendlines of these scores (and sub-scores) are also included in Home Health Record 126.

Home Health Record Generator 116 creates and maintains Home Health Record 126 as certain information dynamically changes over time. For example, whenever a new homeowner is added to VFM system 100, Home Health Record Generator 116 creates entries for the various static information relating to that homeowner's residence (e.g., user profile data, geographic data, equipment and infrastructure and related operational data, etc.). Moreover, as dynamic sensor data is received and processed over time, Home Health Record Generator 116 stores and updates Home Health Record 126 to reflect such dynamic data, including alerts, actions and other related data for access by users, providers and various components of VFM system 100.

In addition to integrating VFM Server 110 with Service Provider 130 and Other Provider 140 networks, the Homecare Network also integrates the premises 150 of homeowners and owners of business and other entities. In this manner, VFM system 100 monitors the changes that occur over time to the infrastructure and equipment within those premises 150, detects abnormal conditions and generates related alert-action pairs in an effort to address those abnormal conditions over time (e.g., iteratively troubleshooting the root cause of underlying problems and providing proactive longer-term home maintenance solutions).

At a typical homeowner's premises 150, VFM system 100 includes a Sensor Network 156 to monitor the various equipment and infrastructure installed in the home, such as Devices 154 in various locations throughout premises 150. It should be emphasized that individual sensors do not necessarily bear a one-to-one relationship with each item of equipment. For example, a leak detection sensor may be placed strategically at or near a pipe valve interconnecting multiple pieces of equipment. Moreover, temperature sensors may be placed in a particular area to ensure that excessive heat (or cold) does not negatively impact the operation of nearby equipment. While the permutations are infinite, it is important to note that Sensor Network 156 provides continuous data that may only indirectly relate to particular equipment.

Moreover, the placement of such sensors is of particular importance. In one embodiment, information about the precise location of each sensor (relative to nearby equipment and its room and home environment) is stored in Home Health Record 126 and utilized in the process of predicting alerts and corresponding actions. A potential action may also include the addition, removal or relocation of one or more sensors.

In one embodiment, an on-site Premises Controller 158 filters and processes data from Sensor Network 156 before delivering it over the Internet 105 to VFM Server 110. Premises Controller 158 filters such data in part to address the impracticality of sending to VFM Server 110 the entirety of the raw data generated by every sensor.

Sensors may well vary in how frequently they generate raw data and how frequently they are sampled. Premises Controller 158 effectively “normalizes” this variability across different sensors through the filtering process, in which data for certain types of sensors are more significantly filtered than for other sensors (depending, for example, on the likely rate of change of such raw data over time).

Moreover, Premises Controller 158 also normalizes the units of raw data among various sensors through a conversion process. As a result, the converted data sent by Premises Controller 158 to VFM Server 110 can be meaningfully compared across different sensors (e.g. to determine relative statistically significant changes over time).

In one embodiment, the frequency and granularity of monitored data (as well as the schedule for delivery of such data to VFM Server 110) is adjustable based upon actions (i.e., commands) from VFM Server 110. For example, to diagnose a potential abnormal event, VFM Server 110 may invoke Premises Controller 158 to automatically adjust the frequency and/or granularity of monitored data to gather more information to facilitate the prediction of further alerts and/or corresponding actions.

Communication with VFM Server 110 is managed by VFM Server Interface Module 152, which communicates with Communications Assistant 124 on VFM Server 110 via Internet 105. Premises Controller 150 and VFM Server Interface Module 152 may be implemented on a standard desktop or laptop computer (along with standard hardware, firmware and operating system 151) or, in other embodiments, on a smartphone or as separate physical standard or custom hardware devices.

Homeowners (and owners of businesses and other types of premises) can also access VFM Server 110 via a voice-enabled and/or web browser interface or custom app 165 on their devices 160, such as mobile devices, or through similar interfaces via their laptop or desktop computers (each of which typically includes standard hardware, firmware and operating system 161).

In this manner, homeowners receive alerts and corresponding actions, as well as provide feedback (e.g., requested information) or initiate queries. For example, a homeowner can submit a voice query regarding the relative efficiency of their AC system within a specified timeframe, and receive a summary of historic performance levels, as well as targeted comparative recommendations for upgrades or replacements that will be more efficient from the perspective of their AC system, as well as any individual item of equipment.

Another key component of the architecture of VFM system 100 (alluded to above) is the Homecare Network that integrates the homeowner network with networks of various service and other providers. Each Service Provider system 130 includes (in addition to standard hardware, firmware and operating system 131) a VFM Server Interface Module 132 (e.g., embodied in the provider's physical server, whether on-premises or in the cloud) that interacts with corresponding Service Provider Manager 112 functionality in VFM Server 110. In other embodiments, Service Provider system 130 may be implemented as one or more physical desktop or laptop servers (and/or mobile or customized hardware or software devices).

Similarly, Other Provider systems 140 (e.g., owned by equipment vendors, insurance or warranty companies, etc.) also include standard hardware, firmware and operating system 141, along with a VFM Server Interface Module 142.

The VFM Server Interface Module 132 or 142 in each provider's server communicates with the Service Provider Manager 112 or Other Providers Manager 113 in VFM Server 110. It receives and analyzes data from VFM Server 110 (such as periodic data derived from Home Health Record 126 summarizing the state of each homeowner's equipment and infrastructure) and provides feedback, such as recommended actions regarding a recent alert, discount service and upgrade offers, etc. Such data can be analogized to a “carfax” report with respect to the state of a homeowner's equipment and infrastructure over time.

In addition to the advantages of repeat business and upsell opportunities, this architecture enables benefits such as “just-in-time” service calls (e.g., based on knowledge of the state of a homeowner's equipment) and better overall matching of specific needs of homeowners with providers having relevant expertise. A service provider might, for example, combine a just-in-time service call with an upcoming maintenance task. In one embodiment, custom APIs facilitate more efficient and complex functionality, such as detailed “just-in-time” scheduling, troubleshooting actions with immediate feedback to the provider, etc.

In other embodiments, VFM Server 110 matches the “supply” of providers with the “demand” of a network of properties (including institutional owners of multiple properties). For example, VFM Server 110 can leverage its knowledge of the availability of a particular service provider's schedule and the need for relevant service by multiple homeowners within a particular geographic area (each of whom has received an outstanding action calling for such service within a month). As a result, both homeowners and providers benefit from the enhanced efficiency afforded by this “integrated scheduling” functionality.

As noted above, VFM system 100 functional modules depicted in FIG. 1 can be implemented in hardware, software and combinations thereof, and such functionality can be divided into sub-modules or combined together across one or more physical servers in accordance with design and engineering tradeoffs by those skilled in the art without departing from the spirit of the present invention.

Moreover, to the extent that functional modules within VFM Server 110 (or those included in Premises Controller 158 or in provider or other external servers) are implemented in software, such software is embodied in physical non-transitory computer-accessible storage media (i.e., memory) from which it is invoked for execution by one or more CPUs or other physical processing units.

As noted above, Premises Controller 158 continuously processes raw data from the sensors via local sensor network 156 at the premises 150. After filtering and converting this raw data as described above, Premises Controller 158 streams this processed sensor data to Data Monitor 115 in VFM Server 110.

Data Monitor 115 also receives environmental and other external data from a variety of external data sources 128. For example, local weather forecasts provide valuable input that affect predictions of abnormal conditions. Current heavy rain might explain why elevated sump pump usage is not abnormal, while a storm warning might result in preventive charging of batteries in a solar system. Other external environmental data can include air, water and soil quality, as well as major nearby events, such as an earthquake, flood or infectious disease outbreak or pandemic.

Data Monitor 115 parses this sensor-based and environmental data for each home, and processes and formats the data for input to the prediction engines. It should be noted that the processed data provided to the prediction engines includes timestamped current and historical raw data (in one embodiment), as well as data that have been filtered and converted by Premises Controller 158.

Such information enables the prediction engines to infer proactively various states of the equipment, systems and infrastructure of the home. For example, is a unit of equipment (or a component thereof) wearing more rapidly than normal, or nearing the end of its useful life? Is a unit of equipment or a system (e.g., an HVAC system) operating more or less efficiently than normal? These and other current or prospective operational states can be inferred from this raw or processed data.

In addition to this processed current and historical sensor and environmental data, additional information from Home Health Record 126 is extracted for use by the prediction engines. For example, historical alert and corresponding action data is extracted as well, including metadata from such alerts and actions, such as timestamps, types or categories and various other attributes (discussed in greater detail below).

Such inputs further include the home's geographic location and identification of installed equipment and infrastructure, including its location (e.g., room or more precise position) within the home, as well as its age, warranty information and service history (including service provider info). Also included are operational models, performance characteristics and specifications of installed equipment and comparable units, as well as user profile information (e.g., reflecting particular occupants' desire and ability to perform certain levels of troubleshooting). In one embodiment, data across multiple properties are provided as input to enable the prediction engines to consider “inter-property” factors such as shared risks and pooled resources, comparative performance benchmarks, etc.

It will be apparent to those skilled in the art that a variety of other types of information (whether from sensors, external data sources or elsewhere) can be included in Home Health Record 126 and provided as inputs to the prediction engines without departing from the spirit of the present invention. Once Data Monitor 158 has completed the parsing, formatting and other processing of this data, Home Health Record 126 is updated with this newly processed data, which are provided to the prediction engines.

Before discussing the prediction engines, it is helpful to consider an overview of the dynamic aspects of the iterative process by which the key components of VFM system 100 work together to process raw data over time, feed such data (both current and historical) into prediction engines to detect abnormal conditions, and generate alerts and corresponding actions designed to address the root cause of underlying problems of which such abnormal conditions are often mere symptoms.

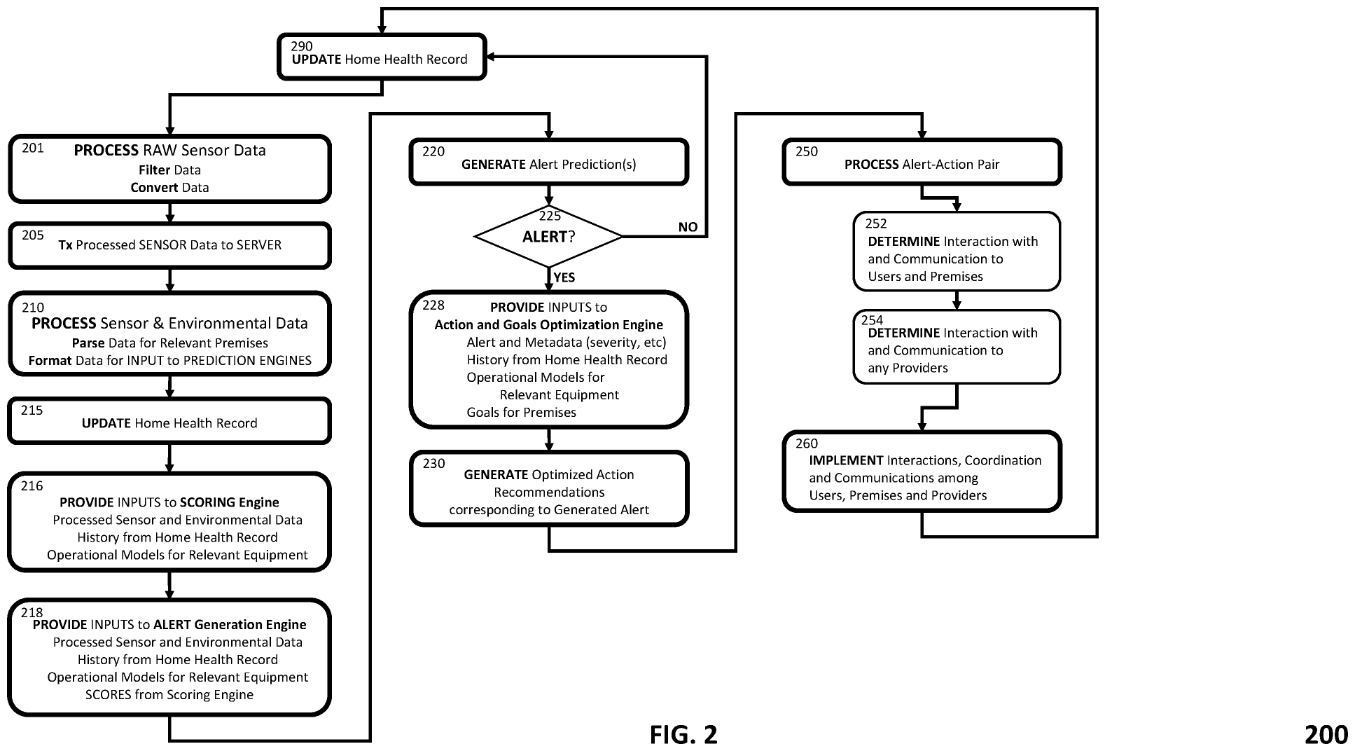

Turning to FIG. 2, flowchart 200 illustrates one embodiment of such a continuous process. While flowchart 200 focuses on the process within a particular premises 150, it should be noted that VFM Server 110 manages multiple different premises 150 simultaneously. In certain scenarios, this enables cross-premise synergy, such as a provider coordinating multiple service calls based on similar alerts or other problems across premises 150 within its service area.

Beginning with step 201, the sensors in sensor network 156 capture raw sensor data as air, water, soil and other sensors detect changes over time. Premises Controller 158 filters, converts and otherwise processes such data (as discussed above) and, in step 205, transmits such processed sensor data to Data Monitor 115 in VFM Server 110.

In step 210, Data Monitor 115 further processes such sensor data, along with historical data from Home Health Record 126 and environmental data (e.g., from External Data Sources 128), and parses such data into a format suitable for input to the prediction engines. In step 215, Data Monitor 115, in conjunction with Home Health Record Generator 116, updates Home Health Record 126 to reflect the new data since the prior iteration of this process 200.

In step 216, Data Monitor 115, in conjunction with Prediction Engine Manager 117, provides such inputs to Scoring Engine 118 (the functionality of which is described in greater detail below), which updates relevant scores (home reliability, home efficiency, fire risk, etc.). Though not shown, Home Health Record 126 is updated to reflect these revised scores.

In one embodiment, Prediction Engine Manager 117, in step 216, provides the same inputs, along with these updated scores, to Alert Generation Engine 120, which, if it detects an abnormal condition, generates (in step 220) an alert with associated attributes, as is also discussed in greater detail below. In step 225, Prediction Engine Manager 117 determines whether the predicted alert should be issued as an alert requiring an associated action. If not, Home Health Record 126 is updated in step 290, and the process returns to step 201 to process raw sensor data during the next iteration of process 200.

Otherwise, the alert is processed by Prediction Engine Manager 117, which (in one embodiment shown in step 228) provides the predicted alert and associated attributes, along with the scores and other input data from Home Health Record 126, to Action and Goals Optimization Engine 122. In step 230, Action and Goals Optimization Engine 122 generates an action (i.e., the next recommended troubleshooting step, as discussed in greater detail below) that corresponds to the current alert (thus creating a current alert-action pair) and is optimized in accordance with a homeowner's predefined user goals.

In step 250, Prediction Engine Manager 117 processes the current alert-action pair (e.g., to implement that next recommended troubleshooting step) which, in one embodiment, involves coordination with Communications Assistant 124 and Premises and User Manager 114 (among other modules of VFM Server 110) to determine, in step 252, the interaction with and communication to the relevant premises 150 and associated users 160. For example, a recommended action may be determined to require communication to a homeowner to implement that action. In another embodiment, such action may be performed automatically by Premises Controller 158.

Similarly, in step 254, Prediction Engine Manager 117 coordinates with Communications Assistant 124 and Service Provider Manager 112 and Other Providers Manager 113 (among other modules of VFM Server 110) to determine the interaction and communication with any relevant Service Provider 130 or Other Provider 140. For example, a recommended action may be performed entirely or in part by a provider (e.g., scheduling a service call). In another embodiment, a relevant provider may supplement the recommended action with additional feedback.

Finally, in step 260, the recommend action is coordinated, communicated to and implemented by the relevant parties, such as providers, users and automated functionality built into Premises Controller 158. At that point, Home Health Record 126 is updated in step 290, and the process returns to step 201 to process raw sensor data during the next iteration of process 200. In one embodiment, the results of such implementation are incorporated into the update of Home Health Record 126. For example, a homeowner might provide feedback indicating whether or not the action resolved the current alert (i.e., symptom of an underlying problem).

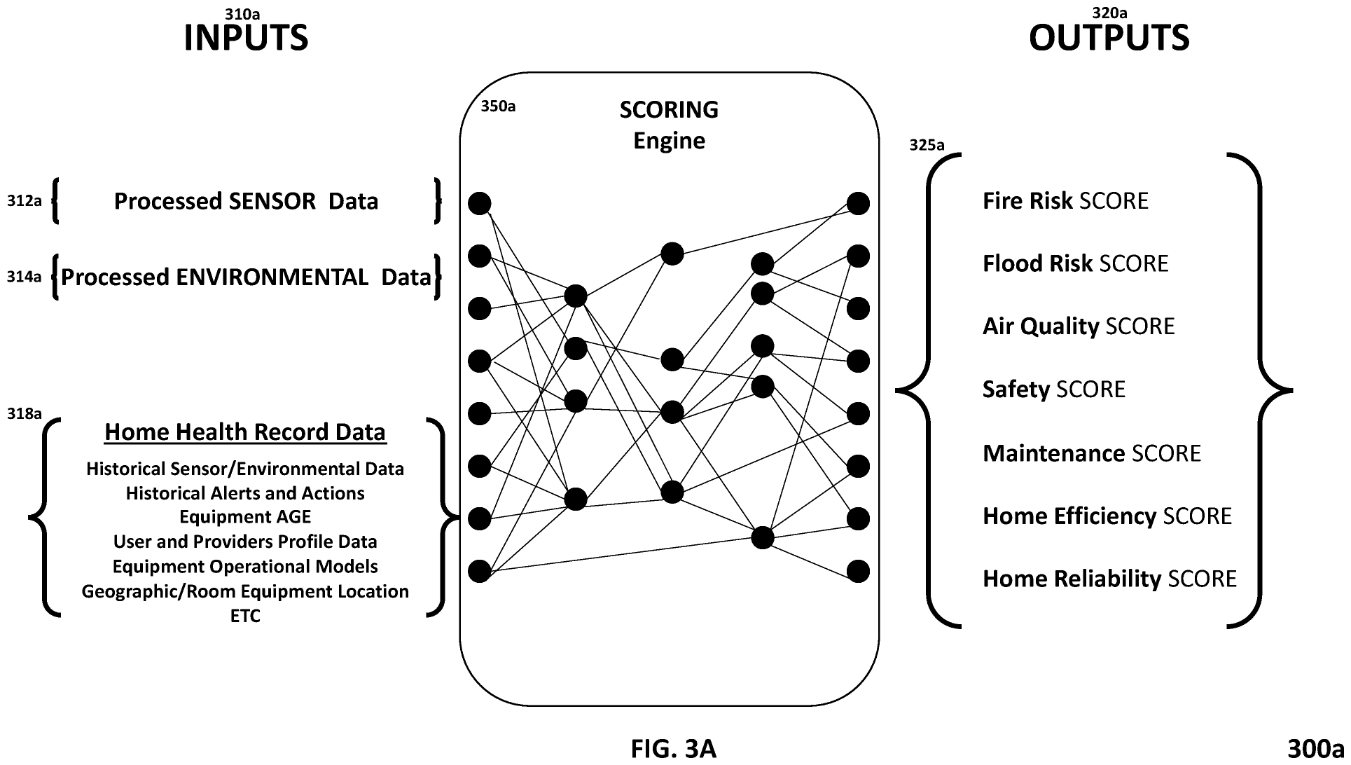

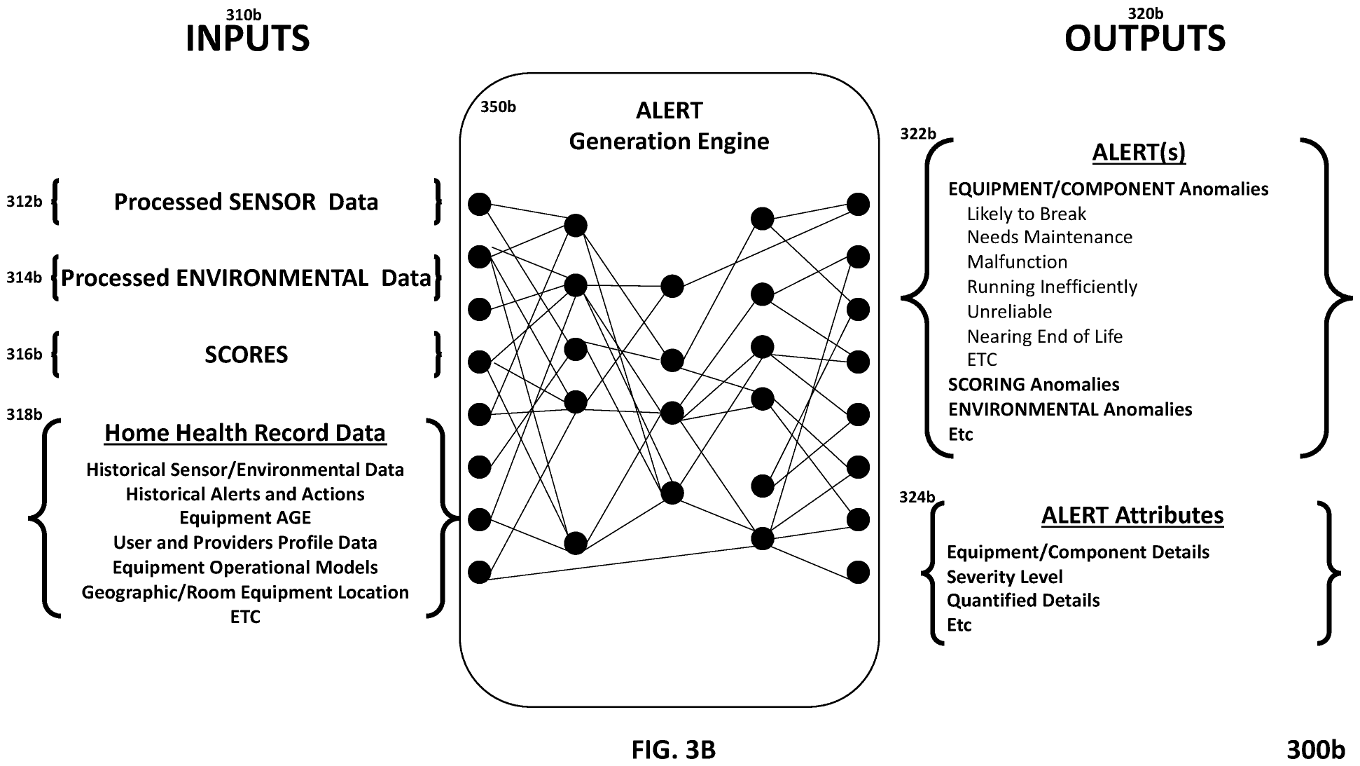

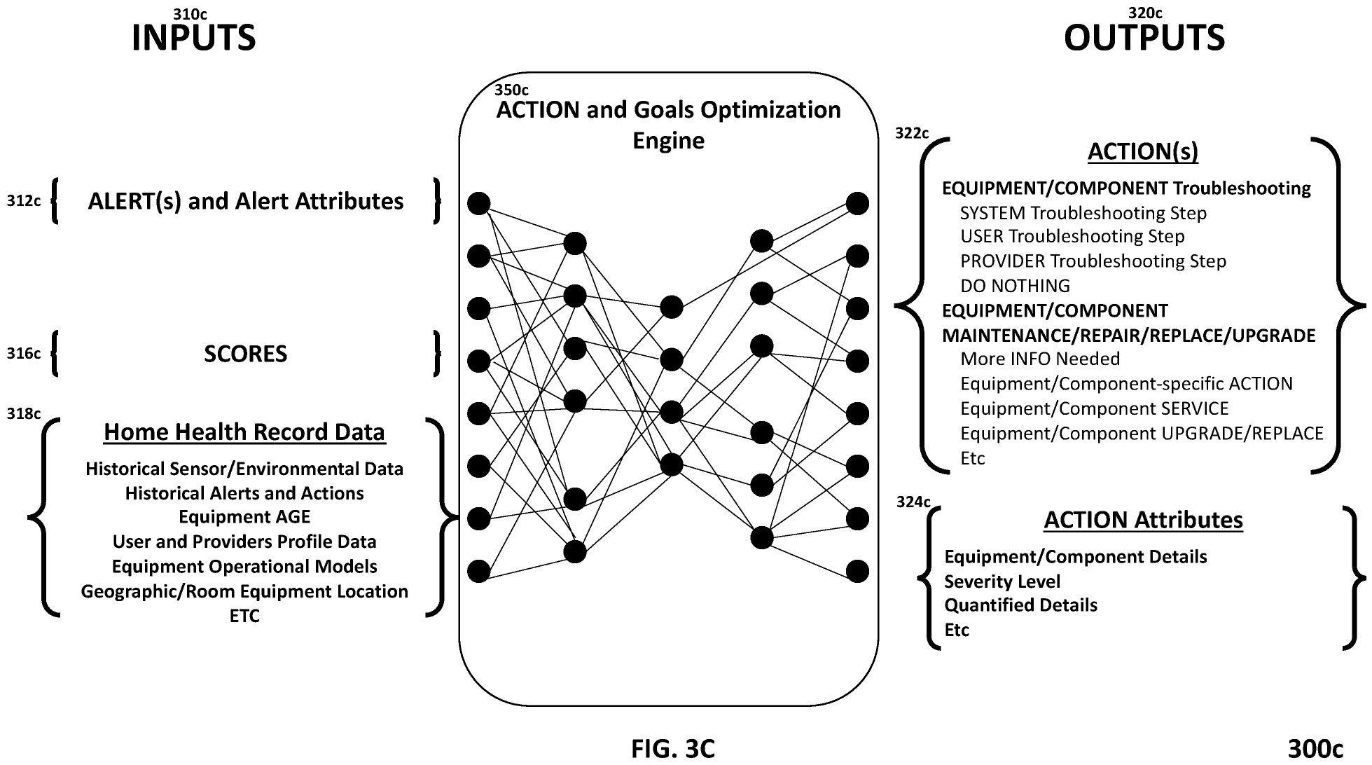

Turning to FIGS. 3A, 3B and 3C, the functionality of one embodiment of the prediction engines is now described. VFM Server 110 integrates three distinct prediction engines (Scoring Engine 118, Alert Generation Engine 120 and Action and Goals Optimization Engine 122), each of which is implemented as a machine-learning-based neural network that employs predictive techniques to assess likely outcomes. In other words, given a large set of inputs, the combination of which has very likely not been encountered before, each of these prediction engines assesses and “predicts” the most probable outcomes.

In alternative embodiments, the prediction engines are implemented with different forms of unsupervised machine learning, statistical analytics, rules-based heuristics and other techniques (or combinations thereof). In such embodiments, the prediction engines still generate similar outputs in response to similar inputs (as compared with their machine-learning neural network counterparts) without departing from the spirit of the present invention.

In one embodiment, the inputs described above are provided to the prediction engines on an iterative basis. In other words, on a very frequent basis (e.g., once per second), the inputs are provided to the prediction engines, which ultimately may yield a predicted alert and optimized action. During most iterations, insufficient changes have occurred to generate an alert. Once an alert is generated, a corresponding action (optimized for predefined User Goals) is generated and then implemented. One embodiment of these prediction engines is described below.

Illustrated in diagram 300a of FIG. 3A, Scoring Engine 350a utilizes a set of inputs 310a (discussed above) to generate a set of outputs 320a representing the most probable assessment of the state of certain higher-level (e.g., whole-home) conditions and risks. For example, in one embodiment, it generates scores 325a for overall “Home Efficiency,” “Home Reliability,” “Safety,” “Maintenance” (e.g., how well a home has been maintained over time), “Fire Risk,” “Flood Risk” and “Air Quality.” All of these scores 325a facilitate the generation of alerts and actions by the other prediction engines.

For example, a relatively low Home Efficiency score may tip the balance in generating an alert with respect to otherwise borderline efficiency data regarding particular equipment or systems. Similarly, the predicted action corresponding to that alert might be one that would not have been generated had the Home Efficiency score been higher (such as a particular adjustment of settings, an upgrade to a more efficient model or even the addition or replacement of particular equipment or modification of the home's infrastructure over time until the Home Efficiency score increases sufficiently).

In one embodiment, Scoring Engine 350a generates sub-scores (e.g., for the reliability of an individual item of equipment) in the process of generating a score 325a reflecting the state of the home. These sub-scores are also maintained in Home Health Record 126.

Scoring Engine 350a generates outputs 325a that reflect system-wide and, in particular, whole-home perspectives based on various aspects of current and historical sensor data regarding one or more items of equipment and infrastructure, as well as external environmental data. For example, the reliability of an individual item of equipment may be impacted by its age, prior alerts and corrective actions, repairs, etc. Yet, Scoring Engine 350a will also take into account the reliability of other equipment over time.

Based upon its training, Scoring Engine 350a may effectively prioritize one item of equipment over another (e.g., by assigning different weights to different equipment types), or prioritize based on a system's operational reliability curve or various other factors. Such weighting or prioritization is implemented as an integral part of the Scoring Engine's 350a machine-learning architecture, as opposed to employing a simple weighted average or other predetermined function.

In one embodiment, Scoring Engine 350a is trained with sample sets of inputs yielding a known resulting output score 325a (such as a Fire Risk score, for example, of 85 on a scale of 1 to 100). These sample inputs include current processed sensor data 312a (described above), current processed environmental data 314a (such as weather data from External Data Sources 128), and various data 318a stored in Home Health Record 126 (including, in one embodiment, historical sensor and environmental data, historical issued alerts and corresponding actions, a list of equipment with its room location, operational models and current age, and profile data relating to users and providers).

As a result of such training, Scoring Engine 350a becomes sufficiently proficient at predicting changes in output scores 325a when presented with current and historical values of this set of inputs 310a that it has never encountered before. Upon each iteration of VFM system 100, Scoring Engine 350a predicts changes (if any) in these output scores 325a based upon changes in the values of the inputs 310a that have occurred since the prior iteration.

Turning to FIG. 3B, diagram 300b illustrates how, in one embodiment, Alert Generation Engine 350b utilizes a set of inputs 310b (in this embodiment, the same set of inputs provided to Scoring Engine 350a, along with the scores generated by Scoring Engine 350a, to generate a set of outputs 320b reflecting one or more alerts 322b and associated attributes 324b. Inputs 310b include current processed sensor data 312b, current processed environmental data 314b, historical data 318b from Home Health Record 126 (as described above) and the output scores 316b generated by Scoring Engine 350a.

Alert Generation Engine 350b generates predictions regarding the likely existence of emerging system risks—i.e., abnormal conditions. Such abnormal conditions include “scoring anomalies” in which a particular sub-score or score (e.g., a significantly low Home Efficiency score), in the context of the other inputs, suggests a need for corrective action. As will be discussed below, such corrective action could be adjustment of the settings of particular equipment or, in more severe cases, addition of certain equipment or replacement of a particular unit with a newer more efficient model.

Other abnormal conditions include “environmental anomalies.” in which environmental data suggest the need for preventive actions. For example, in the event of a severe storm warning within proximity to a homeowner's premises, Alert Generation Engine 350b might generate (taking into account the context of the other inputs 310b) a preventive action such as testing the operation of a sump pump.

A primary function of Alert Generation Engine 350b is to generate alerts 322b representing “equipment anomalies” that relate to particular equipment or components thereof (or more abstract systemic anomalies at a system or whole-home level). For example, did a particular item of equipment (or component, or system comprising multiple items of equipment) experience a “malfunction?” Or is it “unreliable” or “running inefficiently” over a sufficient period of time? Is it “likely to break” based upon its past performance characteristics, or “nearing the end of its life?” Or is it currently “in need of maintenance?”

These and other types of alerts 322b represent outputs 320b of Alert Generation Engine 350b that constitute abnormal conditions reflecting “equipment anomalies.” As noted above, during most iterations of Alert Generation Engine 350b, no alert will be generated. In other words, all systems and individual units of equipment within the home (or even across a network of homes) are operating within “normal operational ranges” and “acceptable risk levels”—at least based upon current sensor data.

But, at some point in time (e.g., when sensor data or environmental data changes sufficiently from the prior iteration), Alert Generation Engine 350b will, during the current iteration, detect an abnormal condition and issue an alert 322b. In addition to generating the alert itself, Alert Generation Engine 350b also generates certain related “alert attributes” 324b.

For example, in one embodiment, the alert attributes 324b identify the particular item of equipment (or component thereof, or higher-level system) to which the alert 322b applies. They further include various “quantified details” relating to such equipment and components, such as a particular temperature or other setting that may relate to the anomaly.

Finally, the alert attributes 324b include a “severity level” indicating the relative significance of the alert 322b. As many alerts are effectively contextual alerts, the severity level often reflects a contextual awareness of the state of the home or equipment system (beyond the state of an individual piece of equipment or component thereof). For example, a problem with an air conditioning unit might increase in severity during a heat wave in the area.

Some alerts 322b are relatively minor and might, for example, result in the automatic adjustment of equipment settings by VFM Server 110, or may require user intervention, but not imminently. Other alerts 322b may require more immediate attention, or may potentially result in more severe problems, even if they do not require immediate attention. The number of different severity levels is the result of design and engineering tradeoffs that will be apparent to one skilled in the art without departing from the spirit of the present invention.

It should be noted that the placement of sensors within a room or area of the home (or within proximity of particular items of equipment or infrastructure) can be very important to the relative accuracy of the sensor data with regard to its desired purpose. In one embodiment, the precise location of each sensor is stored in Home Health Record 126 and used by Alert Generation Engine 350b in the process of generating alerts 322b. In another embodiment, an alert 322b may include “improper placement” of a sensor, which ultimately may result in an action (generated by Action and Goals Optimization Engine 350c) recommending a better location.

As alluded to above, alerts 322b are often contextual in nature. For example, as discussed earlier, Alert Generation Engine 350b might detect abnormally high sump pump activity, but not generate an alert due to the contextual environmental data that such activity has occurred during a period of heavy rain. In other contexts, a forecast of heavy rain might result in the generation of an alert 322b with respect to the sump pump due to its erratic behavior during prior periods of heavy rain, along with the fact that it has not serviced in the interim.

In one embodiment, users may initiate queries to VFM Server 110 (e.g., from a voice-enabled mobile app or web browser interface 165 on a laptop or desktop computer). For example, as noted above, a user might submit a query regarding the relative efficiency of their AC system. Such a query would effectively trigger an alert and related metadata regarding the subject of the alert (e.g., the AC system). In this scenario, Action and Goals Optimization Engine 350c would generate a “response” action including, for example, a summary of the efficiency of the installed AC system (based upon its historic performance) and perhaps a comparative recommendation for an upgrade to a more efficient competitive alternative product.

Providers may also initiate queries to VFM Server 110. For example, a warranty provider may (with a homeowner's permission) initiate queries regarding the homeowner's maintenance history. As a result of a query returning favorable information regarding the homeowner's maintenance record, the warranty provider might offer the homeowner a discount on an extended warranty.

In the event Alert Generation Engine 350a fails to generate an alert (as is likely to be the case during most iterations), then Home Health Record 126 is updated and VFM system 100 repeats the process for the next iteration (i.e., receiving sensor data from Premises Controller 158 of each home, etc.). When an alert 322b is generated, the alert 322b and its associated alert attributes 324b, along with many of the same inputs provided to Alert Generation Engine 350a, are provided as inputs to Action and Goals Optimization Engine 350c.

Turning to FIG. 3C, diagram 300c illustrates how, in one embodiment, Action and Goals Optimization Engine 350c utilizes these inputs 310c (in this embodiment, including alerts and alert attributes 312c, scores 316c generated by Scoring Engine 350a and the same data 318c stored in Home Health Record 126 and provided to the other prediction engines) to generate a set of outputs 320c representing recommended actions 322c and corresponding action attributes 324c.

It is important to emphasize that the actions 322c generated by Action and Goals Optimization Engine 350c are not designed merely to address the associated alert 322b— i.e., the “symptom” of the problem that may be resolved relatively easily in the course of one iteration, or may require a more complex series of actions not yet fully determined. Rather, each action 322c generated by Action and Goals Optimization Engine 350c is the “next action” to be performed—i.e., the next step in a dynamic iterative troubleshooting process.

In other words, follow-on actions (determined during subsequent iterations) cannot necessarily be determined without additional information, such as the results of the current action 322c, user and/or provider feedback and the changes that occur in sensor and environmental data over time. It is this dynamic feedback approach, often involving more than one related alert-action pair, that provides a meaningful simulation of the ideal Virtual Facilities Manager.

Moreover, it should be noted that related alert-action pairs need not involve the same alert. In many cases, a different alert will be generated during subsequent alerts, although its associated action may relate to the same underlying problem. This process effectively diagnoses, as well as addresses, that underlying problem (with timely assistance from homeowners and providers), as shown in the scenarios discussed below.

In one embodiment, Action and Goals Optimization Engine 350c does more than predict the next action that best corresponds with the current alert (in the context of the other inputs, including current and historical data, operational models, etc.). It also takes into account various User Goals to determine which of various potentially relevant actions optimally furthers one or more of these User Goals.

For example, one homeowner may want to optimize for lowest cost, while another might want to optimize for highest energy efficiency. Still others might choose to optimize for least inconvenience regarding service calls and homeowner involvement, or greatest reliability or safety. Various other User Goals will be apparent to those skilled in the art.

The User Goals are not considered merely at the level of an individual item of equipment, but at a higher system or whole-home level (or even across a network of homes). For example, the cost of replacing (as opposed to repairing) a relatively expensive component of a piece of equipment may still outweigh the projected cost of a more expensive future replacement of the entire unit (or of other interdependent equipment in the same system). Action and Goals Optimization Engine 350c performs these comparative analyses based upon operational models and related financial and other data provided as inputs.

Action and Goals Optimization Engine 350c also takes into account systemic considerations when looking at particular equipment to recommend. For example, additional “smart control” devices may be recommended to provide a homeowner with more control over the operational parameters of certain equipment, enabling the homeowner with a greater ability to satisfy an energy efficiency User Goal.

Moreover, in another embodiment, homeowners can specify an ordered priority of combinations of these User Goals, as well as a weighted “optimization function” that has multiple User Goals as parameters. For example, a user might prioritize lowest cost, but with a minimal level of energy efficiency.

As a result of these specified User Goals, Action and Goals Optimization Engine 350c effectively selects, from among a domain of potential actions exceeding a threshold of correlation to the current alert (in the context of relevant historical data), the particular action that most optimally satisfies the User Goals (or function thereof). In short, all other factors being equal, the generated action might differ depending upon a particular homeowner's User Goals.

It should be noted that, while these User Goals provide homeowners with the advantage of some degree of control over the maintenance of their premises, they also provide advantages to providers. For example, homeowners focused on energy efficiency are far more targeted customers for upgrades to more energy efficient models than typical homeowners. In general, the better a homeowner's needs and desires can be matched to the particular products and services offered by certain providers, the more likely a “win-win” outcome can be achieved.

In one embodiment, Action and Goals Optimization Engine 350c employs the scores 325a generated by Scoring Engine 350a (among other inputs) to generate actions 322c that facilitate these “win-win” outcomes between homeowners and various providers. For example, the integration of Home Efficiency scores enables “energy utility” providers to better manage energy usage by homeowners (e.g., by offering discounts for lower Home Efficiency scores over time). Similarly, Maintenance scores enable Warranty providers to incentivize more proactive preventive maintenance behavior over time. And Home Reliability scores enable Insurance providers to make much more targeted risk assessments, such as discounts for higher Home Reliability scores over time.

In the embodiment illustrated in FIG. 3C, Action and Goals Optimization Engine 350c generates various different types of actions 322c. For example, many such actions 322c relate to troubleshooting steps regarding operational malfunctions of an individual unit of equipment or one or more of its components. An action might involve adjusting a setting, reporting status data that is not available via a sensor, flipping a switch, describing a sound and many other actions designed to yield feedback that will inform subsequent troubleshooting steps.

Moreover, certain actions 322c will be performed directly by VFM Server 110 (e.g., over the Internet 105, via Premises Controller 158 or otherwise). Other actions include steps to be taken by the homeowner, including performing actions and/or providing information. Still others may require the intervention of a service provider (including automated notification of the service provider, scheduling, etc.). And certain actions will simply involve waiting for a subsequent alert (e.g., waiting a period of time before determining the next step due to interim changes in sensor and/or environmental data).

Other actions 322c may relate less to troubleshooting and fixing a discrete problem and more to ongoing preventive maintenance tasks. Here too, certain maintenance tasks may involve configuration procedures that are performed automatically by VFM Server 110, while others (e.g., changing a filter) may be performed by homeowners, and still others may require a service provider.

Certain actions 322c may involve “time of day” recommendations, e.g., based on learning the optimal time of day to charge an electric car or operate a pool pump (whether optimized for cost, energy efficiency or other User Goals or combinations thereof). Moreover, systemic factors (such as thermal heat transfer, structural considerations, airflow, etc.) are also taken into account. For example, Action and Goals Optimization Engine 350c may recommend that a dryer that gives off a significant amount of heat be operated in the evening to avoid triggering air conditioning.

Still other actions 322c may involve recommendations to purchase a device or item of equipment or component (to supplement, replace and/or upgrade a unit or component thereof) to address a systemic issue. For example, certain components may wear out with relative frequency, and proactive replacement of such components may result in extending the life of a piece of equipment, or even an entire system (e.g., due to the interdependencies among the operation of particular items of equipment). Here too, these recommendations are affected by the User Goals, whether at the level of an individual item of equipment or a system of equipment, or across the homeowner's entire residence.

As was the case with Alert Generation Engine 350b, Action and Goals Optimization Engine 350c generates not only actions 322c, but also corresponding action attributes 324c. For example, the action attributes 324c identify the particular item(s) of equipment or components to which the action is targeted, as well as quantified details (e.g., a desired setting of an item of equipment, such as a thermostat). They also indicate a severity level, giving the homeowner and/or service provider a sense of the degree of urgency in performing that particular troubleshooting step (and in one embodiment the timeframe or condition necessary before the next step can be determined).

Once Action and Goals Optimization Engine 350c generates an action 322c (along with action attributes 324c), the resulting alert-action pair is then processed by VFM Server 110. In one embodiment, Communications Assistant 124 manages the process of communicating alert-action pairs (and related metadata and other summarized historical data from Home Health Record 126) to homeowners and/or providers.

In some cases, Communications Assistant 124 may determine that the threshold for communicating a particular alert-action pair to a homeowner has not been exceeded. For example, a very minor alert may be associated with “no action” and merely saved in Home Health Record 126 for future iterations. In other cases, the action may be performed by VFM Server 110 without a need even to notify the homeowner. In one embodiment, the homeowner elects whether to receive notifications for particular (e.g., “low severity”) alerts and actions.

In the event Communications Assistant 124 notifies the homeowner of the alert-action pair, then the action 322c will be implemented by VFM Server 110 or the homeowner (depending on the particular alert-action pair). The homeowner may also provide feedback (e.g., after checking for particular status data) and even initiate queries to Communications Assistant 124. As noted above, a query will trigger an alert (during a subsequent iteration) and a corresponding “response” action (e.g., providing information on the status of an item of equipment, a system or a whole-home attribute).

Communications Assistant 124 also notifies homeowners when information is required. For example, as noted above, Communications Assistant 124 may query a homeowner to determine whether a prior suggested action (e.g., changing an air filter) has been implemented.

In some cases, he Communications Assistant 124 will also notify a Service Provider 130 or Other Provider 140. For example, a Service Provider 130 may elect to be notified only of alerts and/or actions (with respect to a specified group of homeowners 160) exceeding a particular severity level. But Service Providers 130 may well be notified even when an alert-action pair is not yet recommending actions requiring a service call.

In this manner, Service Providers 130 have an automated “up-to-date” summary of the status of a homeowner's premises 160 enabling them to be proactive (e.g., recommending a preventive service call) and, at the very least, more efficient when the need for a recommended service call arises. In other cases, a Service Provider 130 may perform remote troubleshooting over the phone or via VFM Server 110 (thereby avoiding the need for a physical service call).

Similarly, Other Providers (insurance, warranty, institutional owners, etc.) 140 may also receive over the Homecare Network similar summary status reports regarding a homeowner's premises 160, including summary scores and sub-scores providing more systemic information. They too can reach out proactively depending upon the particular situation. For example, a warranty provider might offer a homeowner an extended warranty based on an above-average maintenance history or relatively stable performance of particular equipment or systems. Or the warranty provider might offer a discounted warranty for a new unit based on an indication that a particular item of equipment is nearing its end of life.

Many other scenarios for proactive maintenance services will be apparent to those skilled in the art, based upon the valuable “health status” data available to a variety of providers over time. In one embodiment, VFM Server 110 summarizes and targets such information (extracted from Home Health Record 126) for particular types of providers, or even for a specific provider.

Once the action has been generated by VFM Server 110 (but without waiting for a homeowner or provider to implement such action), Home Health Record 126 is updated and the process repeats itself for the next iteration (i.e., receiving sensor data from Premises Controller 158 of each home, etc.). The following scenarios will illustrate relative advantages of the VFM architecture in diagnosing and iteratively troubleshooting particular problems over time.

Having described the various prediction engines of VFM Server 110, another aspect of the present invention is explored, in which VFM Server 110 enables connected providers (such as an insurance provider, managed by Other Providers Manager 113) to offer personalized provider services to targeted subsets of existing and prospective customers. It should be noted that processes and scenarios described below involving insurance providers are broadly applicable to any connected providers in the context of the present invention (with or without use of the above-described prediction engines).

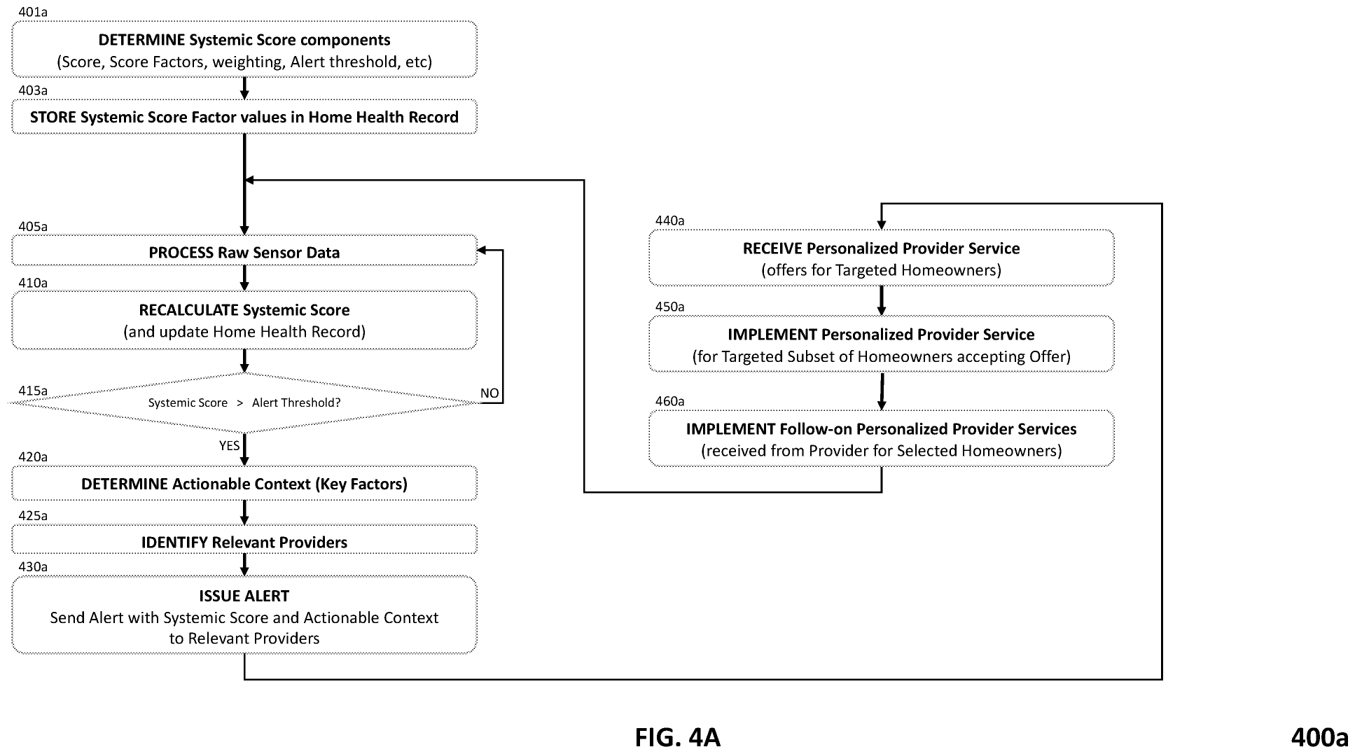

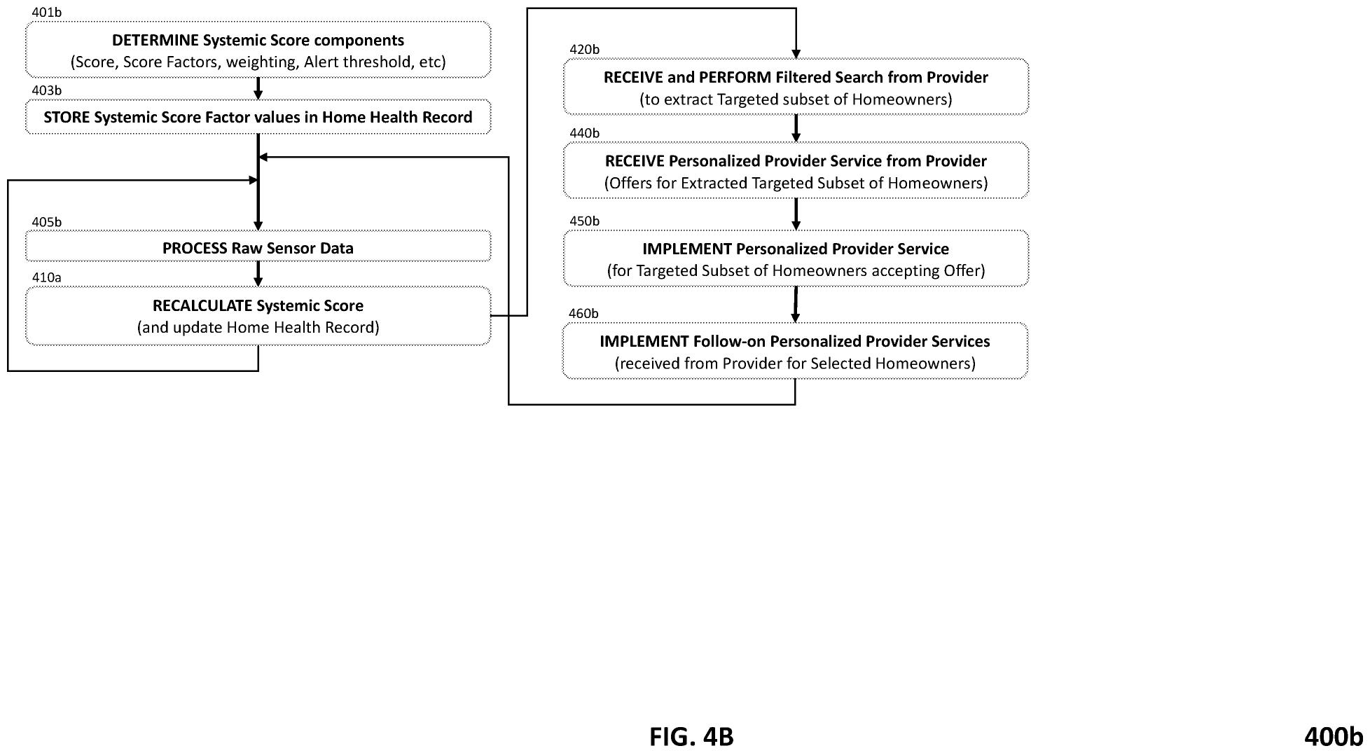

In certain scenarios (described below with respect to FIG. 4A), such offers are generated in response to systemic alerts received over time from various homeowners. In other scenarios (described below with respect to FIG. 4B), insurance providers initiate such offers proactively upon determining the targeted subsets of existing and prospective customers based on the results of filtered searches (submitted to VFM Server 110) of homeowner Home Health Records 126. In still other scenarios, various combinations of these two approaches are employed.

In all of these scenarios, VFM system 100 enables connected providers, such as insurance providers, to leverage data generated by the “smart home” environment of VFM system 100 (stored in Home Health Record 126) by offering personalized provider services to targeted subsets of existing and prospective customers. As is illustrated below, insurance providers leverage this “data visibility” as a means of providing incentives (in the form of personalized insurance services) to minimize the “ROL Scores” of both existing and prospective customers.

### Systemic Scoring

As noted above, Scoring Engine 350a generates various systemic scores reflecting the state of certain higher-level (e.g., whole-home) conditions and risks, including Home Efficiency, Home Reliability, Safety, Maintenance, Fire Risk, Flood Risk and Air Quality. In particular, in one embodiment discussed below (involving insurance providers), Scoring Engine 350a generates a Risk of Loss (ROL) score, reflecting a probability of a homeowner's insurance-related loss.

Such “loss outcomes” include damages across various broad categories, from water to fire to freezing temperatures, among others. Failures of individual items of equipment could lead to leaks or burst pipes, resulting in water damage, as well as overheating that results in fire damage.

For example, pipes could leak or burst due to the home's environment, such as frequent extreme freezing temperatures, or unusually low winter water usage (e.g., due to a homeowner's extended winter vacation). An old water heater that has not been properly maintained may begin to leak. Frequently used refrigerators and dishwashers are among the more likely appliances to experience a leak. Such factors, alone and in combination, could increase the probability of a loss outcome such as major water damage due to leaking or burst pipes.

Similarly, other loss outcomes, such as mold growth, wood rot and unhealthy water quality, may have an increased probability of occurring due to a variety of dynamic factors that change over time. Abnormally high room and appliance temperatures, for example, may contribute to an increased fire risk. A clogged dryer vent (resulting in a significant change in humidity) could increase the probability of a fire. A dehumidifier, particularly as it ages, is at greater risk of an electrical fire due to a large power surge.

In other embodiments, loss outcomes reflect equipment failures or even repairs, shorter lifespans or even significant increases in usage of water or energy. Such loss outcomes may apply to the home as a whole, or to individual systems or appliances. For example, a different systemic score (e.g., equipment failure) may be associated with a different type of risk outcome (e.g., probability of failure of one or more appliances).

In the context of any systemic score, a risk outcome can be quantified by a function of various factors taken alone, as well as in combination. In the context of a ROL (an outcome of significance to an insurance provider), such factors contribute to water damage, fire damage, freeze damage and other loss outcomes.

In one embodiment, a default “ROL Function” is provided and maintained by VFM Server 110 as a function of predefined ROL Factors. In other embodiments, the ROL Function (and the individual ROL Factors or parameters of the ROL Function) are customized by each individual insurance provider. Such customization enables insurance providers to leverage their expertise in assessing risk, as well as differentiate themselves from other insurance providers.

In this embodiment, each insurance provider specifies its own custom list of ROL Factors to be monitored by VFM Server 110. Moreover, the weighting of each ROL Factor in the ROL Function, as well as a threshold ROL value that triggers a systemic “ROL Alert,” is optionally customized by each insurance provider.

VFM Server 110 continuously monitors the relevant ROL Factors for each insurance provider and triggers a relevant ROL Alert when the specified ROL threshold is satisfied. In one embodiment, the ROL Function is a simple weighted sum of ROL Factors, while in other embodiments, the ROL Function is more complex.

In one embodiment, subscores of a whole-home ROL Score are calculated (e.g., for each appliance, room, etc.). The “value” of each subscore reflects both the likelihood of a particular loss outcome and the extent of that loss (i.e., an “expected value”).

For example, consider a ROL Factor such as average thermostat settings in a room over a defined period of time (as compared to a standard “normal” value). As a general matter lower than normal settings lead to condensation, which in turn leads to an increased risk of water damage. The “value” associated with this ROL Factor in this scenario is a relative value as compared to the standard normal value.

Similarly, consider individual appliances, such as a hot water heater, a dishwasher and a refrigerator. Losses such as a water leak or a significant repair can be the result of appliances being “overused” as well as “underused.” ROL Factors such as average energy usage over a defined period of time, as well as length of time between cycles (i.e., frequency of usage), contribute to potential loss outcomes. For example, a leak in a dishwasher's fill line could result from higher than normal energy usage (overuse) or from a lower than normal cycle frequency (underuse).

As noted above, in the context of any ROL Function, individual ROL Factors are weighted based on the extent of their contribution to the resulting ROL Score. Depending on the scenario, certain ROL Factors may have a more significant impact on the likelihood of a loss outcome than others. For example, certain brands of appliances may be more reliable than others. Yet, the age of the appliance may be a more reliable predictor of potential failure than its brand, and may be weighted more heavily.

Moreover, the failure of particular equipment may lead to significant water or fire damage. For example, a rundown water heater could rupture and cause significant water damage. Refrigerators and dishwashers are more likely than other types of appliances and infrastructure to experience water line ruptures. And dehumidifiers (which typically experience a 50-amp surge when first turned on) pose an increased risk of starting an electrical fire as they age.

Weighting ROL Factors in the course of defining any ROL Function inherently requires subjective judgments. For this reason, in one embodiment, each individual insurance provider is provided a mechanism to customize a default ROL Function by selecting the domain of ROL Factors, the weighting of each ROL Factor, the threshold ROL Score that triggers a ROL Alert, and even the nature of the ROL Function itself.

In one embodiment, in addition to taking into account the impact of individual ROL Factors, the ROL Function reflects the impact of combinations of ROL Factors. For example, high humidity in an attic has greater impact on a potential loss outcome if a hot water heater is present in the attic.

Moreover, the frequency of usage of certain types of appliances (e.g., dishwashers) may be weighted more heavily than other types of appliances (e.g., microwave ovens) based on the likelihood and impact of particular loss outcomes (water leaks, electrical fires, etc.). Other dependencies among ROL Factors are considered in defining a ROL Function with regard to energy usage (e.g., the relationship of energy consumption to the frequency of changing a filter in a dryer or dehumidifier) and water usage (e.g., greater likelihood of low water usage leading to burst pipes during freezing conditions), as well as various other ROL Factor categories, including water quality, temperature, humidity, air quality, etc.

Table 1 below illustrates a sample list of ROL Factors that are weighted, alone and in combination, in different embodiments of ROL Functions. Certain ROL Factors are specific to individual equipment and infrastructure, while others characterize higher-level system and whole-home attributes.

TABLE 1

| ROL FACTOR | DESCRIPTION (re Probability of Loss Outcome) |
|---|---|
| STATIC | |
| Home Location/Weather | losses due to Local Climate and Weather Events |
| Square Footage of Home | increased probability of losses in larger homes |
| Number of Floors | increased probability of Water Damage |
| Facade Type | losses due to Termites/etc (eg, more likely with Stucco) |
| Roof Type | losses due to Water and Hail damage |
| Pipes (Copper, PVC, etc) | losses due to Pipe Burst and related Water Damage |
| Flooring Type | losses due to Water Damage, Replacement, etc |
| Hot Water Heater (incl Location) | losses due to Water Damage |
| Dryer Type | losses due to Dryer Fire |
| # of Faucets, Toilets, etc | losses due to Water Damage |
| DYNAMIC | |
| Age of Home/Equipment | losses due to Failure and Replacement |
| History of Alerts and Actions | timing and frequency of particular types of Alerts and Actions |
| | Failures and repairs |
| History of Service | number and frequency of prior service calls, repairs, etc |
| CONTINUOUS Runtime Factors | runtime of Appliances and Systems (daily/monthly usage, etc) |
| Average daily usage | eg, dishwasher, AC unit, etc |
| Cycle Length | transform daily runtime into average cycle length (stop-start) |
| | Eg, 1 hour to Cool, 2 hours to Heat, etc |
| | Increased Length of Cycle indicates unit “working harder” |
| Cycle Count/Frequency | number of cycles per day with given frequency |
| Power Usage | on/off and rate of change, average watts/day, peak consumption |
| | Also cycle counts and frequency |
| | Also change in startup consumption (eg, higher over time) |

### Actionable Context

While continuously recalculating the ROL Score of each homeowner, Scoring Engine 118 of VFM Server 110 also, in one embodiment illustrated in FIG. 4A below, checks to determine whether the ROL Score exceeds a predefined threshold. If so, it issues a ROL Alert to a relevant subset of insurance (or other) providers.

But, as noted above, the ROL Score alone is often insufficient to enable an insurance provider to make a meaningful assessment of a ROL Alert, due to a lack of contextual awareness. To make the ROL Alert actionable, an insurance provider needs context to determine which of its personalized insurance services, if any, is appropriate for that particular homeowner.

In one embodiment, VFM Server 110 also generates actionable context associated with each ROL Alert. The actionable context (also transmitted to the providers receiving the ROL Alert and ROL Score) includes the key ROL Factors that led the ROL Score to exceed the predefined threshold.

It should be noted that these key ROL Factors are not necessarily the most heavily weighted ROL Factors in the ROL Function. Instead, they are the ROL Factors that most contributed to the change in the ROL Score that led to the ROL Alert. For example, while the age of a home (or even a particular appliance) might be a relatively significant (heavily weighted) ROL Factor, a significant change in the ROL Score over a short period of time may well have resulted from an abrupt change in a less heavily weighted factor (e.g., a highly unusual power spike in an appliance that typically exhibits a very consistent pattern of power consumption).

As noted above, there are many well-known machine-learning and other algorithms for identifying actionable variables that have a significant effect on outcomes. The present invention employs such algorithms in the context of systemic alerts, such as ROL Alerts, to identify the key ROL Factors that most contributed to the change in the ROL Score that resulted in it exceeding the predefined threshold.

In one embodiment, VFM Server 110 identifies the ten key (“most impactful”) ROL Factors that led to the ROL Alert, and transmits (to each relevant provider) those ten key ROL Factors (and their recent historical values) as the actionable context accompanying the ROL Score that triggered the ROL Alert. In other embodiments, each insurance provider specifies in advance these key ROL Factors, or a custom algorithm for identifying such factors.

Upon receiving this actionable context, each insurance provider may make different decisions as to which personalized insurance services, if any, to offer the particular homeowner associated with the ROL Alert. Moreover, such decisions may be made over time, reflecting various different ROL Alerts from many different homeowners.

For example, upon determining that a particular homeowner's ROL Alert was likely associated with an aging AC unit that is likely to fail in a short period of time, an insurance provider might offer a discounted replacement in an effort to reduce the homeowner's ROL Score in the near term. In other scenarios, that same discounted replacement offer could be extended to a group of homeowners experiencing similar ROL Alerts over the past year (based on similar key ROL Factors included in their associated actionable context).

### Personalized Provider Services

Whether an insurance provider receives ROL Alerts over time (as discussed in FIG. 4A below) or proactively performs a filtered search of homeowner Home Health Records 126 (as discussed in FIG. 4B below), VFM system 100 enables insurance providers to identify a relevant subset of existing and prospective customers to which the insurance provider can offer one or more personalized insurance services. In either scenario, the integrated provider network of VFM system 100 provides a two-way communication mechanism that enables insurance and other providers to identify a relevant subset of existing and prospective customers, and to offer personalized provider services targeted specifically to such customers (whether such offers are targeted to the entire subset of homeowners or personalized to each individual homeowner).

This integrated provider network offers visibility into the home (whether via ROL Alerts or filtered searches of homeowner Home Health Records 126) as well as a mechanism for offering and implementing desired personalized provider services. In effect, providers can “select their customers” as well as incentivize such customers to improve their systemic scores.

In this manner, providers can better service existing customers by offering personalized incentives that would not be possible without the visibility into their customers' behaviors over time provided by VFM system 100 with its integrated provider network. Providers can also attract new “desired” customers with targeted offers, again made possible by this visibility into customer behavior via ROL Alerts (including actionable context) and filtered searches of homeowner Home Health Records 126.

In the context of insurance providers, these personalized insurance services are effectively without limit, as illustrated by various sample scenarios below. For example, insurance providers may offer home inspections to assess individual risks—i.e., to supplement homeowners' Home Health Record 126 and improve the accuracy of future ROL Scores.

Home inspections could be free or discounted, perhaps based on the personalized information available to each insurance provider. Such inspections could be physical or virtual, and may result in follow-on maintenance and other services (including equipment repair or replacement, the addition of sensors or even additional appliances and infrastructure). Each such inspection improves the accuracy of future ROL Scores via subsequent alerts and actions, particularly if inspections are repeated over time (e.g., revealing the additional or replacement of equipment and infrastructure).

Other personalized insurance services are targeted at the “deferred maintenance” problem. Deferred maintenance issues may be revealed not only through home inspections, but from ROL Alerts revealing the need for targeted maintenance offers. For example, maintenance-related actions, such as flushing hot water heaters, cleaning dryer vents, changing air filters and cleaning gutters (among many others), may be the subject of targeted services that not only improve ROL Scores over time, but may also reveal other preventive maintenance opportunities, including the need to repair and replace equipment or supplement equipment and infrastructure.

Targeted equipment replacement offers are made possible by the visibility into attributes such as the age and condition of particular equipment, whether due to ROL Alerts, homeowner inspections and/or filtered searches into homeowner Home Health Records 126. Even something as simple as the age of a particular appliance reveals useful “targeting” information to providers.

Other personalized insurance services include free or discounted sensors, enabling additional future visibility into the performance of particular equipment and infrastructure. Such sensors include, for example, water and leak sensors, temperature and humidity sensors, air and water quality sensors, power sensors and many others. Installation of such sensors will improve the accuracy over time of ROL Scores, future alerts and actions, and related benefits from the expanded visibility provided by supplementing homeowners' Home Health Records 126.

Other examples of personalized insurance services relate more directly to the features of insurance policies themselves. For example, discounted premiums may be offered to existing customers, as well as “desired” prospective customers, with relatively low ROL Scores.

Whether offering discounts or other incentives on insurance premiums, sensors or home inspections, or routine maintenance, specific repairs or replacement of equipment, or supplemental equipment and infrastructure, these personalized insurance services can be broad-based or specific to a system or individual appliance. As noted above, they can be targeted to prospective as well as existing customers, and can be as personalized as desired by the provider (from an individual homeowner to various groups or categories of homeowners).

In this manner, VFM system 100 leverages the provider network and continuous visibility into homeowner behavior (including ROL Alerts with associated actionable context, as well as a mechanism for filtered searches of homeowner Home Health Records 126) to enable insurance providers to offer targeted personalized insurance services to existing and prospective customers. The result is a “win-win” scenario in which insurance providers can improve their relationships with existing customers (e.g., via dynamic pricing and cross-sell opportunities) and broaden their reach to “desired” prospective customers, while homeowners obtain the benefits of reduced prices for these services, including insurance premiums, as well as being incentivized to reduce their ROL Scores and the overall expense of home maintenance over time.

### Identifying Targeted Homeowners for Offers of Personalized Insurance Services

Turning to FIG. 4A, flowchart 400A illustrates one embodiment of a process by which connected providers identify a targeted subset of existing and prospective customers in response to systemic alerts. While this process is described below in the context of insurance providers and ROL Alerts, these concepts are equally applicable to other types of providers and systemic alerts. Starting at step 401a, VFM Server 110 determines the systemic score components.

For example, in the context of insurance providers, VFM Server 110 determines a ROL Function, the output of which is a ROL Score, and the parameters of which are a set of weighted ROL Factors. A ROL Alert threshold is also defined to trigger a ROL Alert if that threshold is exceeded. As noted above, in one embodiment, these components are predefined, including a default set of individual ROL Factors and their weights, as well as the ROL Function that generates the ROL Score and the ROL Alert threshold for triggering a ROL Alert. A default algorithm for determining the key ROL Factors of the actionable context associated with a ROL Alert is also predefined.

In other embodiments, these components are determined by each insurance provider, in which case Scoring Engine 118 computes a ROL Score for each distinct ROL Function associated with an insurance provider defining its own ROL Function. Insurance providers also may substitute their own actionable context algorithm for determining key ROL Factors associated with a ROL Alert.

In still other embodiments, individual insurance providers determine only some of these components. For example, an insurance provider may specify only a subset of default ROL Factors and their weights, but otherwise rely on the default ROL Function and ROL Alert threshold, as well as the default algorithm for determining key ROL Factors associated with a ROL Alert.

Having determined these key components in step 401a, VFM Server 110 then, in step 403a, stores them, including initial ROL Factor values, in each homeowner's Home Health Record 126 (with certain components, in some embodiments, stored in Database 125). In step 405a, VFM Server 110 processes raw sensor data in a manner similar to that described in FIG. 2 above.

In particular, in step 410a, Scoring Engine 118 recalculates each homeowner's ROL Score on a continuous basis and stores it, along with modified ROL Factor values, in Home Health Record 126. In step 415a, VFM Server 110 compares the ROL Score to the predefined ROL Alert threshold. In most cases, the ROL Score will not exceed the ROL Alert threshold, in which case processing returns to step 405a.

If the ROL Score exceeds the ROL Alert threshold, Scoring Engine 118 determines the actionable context in step 420a. As discussed above, it employs the relevant algorithm to identify the key ROL Factors that most contributed to the change in the ROL Score that caused it to exceed the ROL Alert threshold. In one embodiment, the actionable context includes the ten most significant ROL Factors, along with their current values. In another embodiment, prior historical values of such ROL Factors (maintained in Home Health Record 126) are included.

In step 425a, VFM Server 110 determines the relevant insurance providers to whom the ROL Alert and actionable context will be transmitted. In one embodiment, all insurance providers are included by default (unless they opt out), while in other embodiments only certain insurance providers receive particular types of ROL Alerts. In still other embodiments, non-insurance providers may also receive ROL Alerts.

In step 430a, VFM Server 110 issues the ROL Alert, and transmits the ROL Score and actionable context to the relevant insurance providers. At that point, one or more individual insurance providers may elect to offer a personalized insurance service to a specified subset of homeowners (i.e., existing and/or prospective customers).

Upon receiving each such offer, in step 440a, VFM Server 110 proceeds to implement each such offer, in step 450a, with respect to the designated targeted subset of homeowners, and, in step 460a, to implement any follow-on personalized provider services with respect to homeowners that accepted such offers, after which processing returns to step 405a. In one embodiment, the implementation of the personalized insurance service involves merely transmitting the offer to each specified homeowner, while enabling subsequent communications between homeowners and insurance providers via the provider network of VFM Server 110. In other embodiments, a predefined interactive process is implemented by VFM Server 110.

This communication between homeowners and insurance providers (via VFM Server 110) is illustrated in greater detail in the scenarios below. As noted above, insurance providers need not wait to process ROL Alerts over time in order to offer personalized insurance services to selected existing and/or prospective customers. They may also (or in lieu of the process illustrated in FIG. 4A) submit such offers proactively to targeted subsets of existing and/or prospective customers identified via filtered searches of homeowners' Home Health Records 126, as discussed below.

Turning to FIG. 4B, flowchart 400b illustrates an embodiment of a process which enables connected providers to offer personalized provider services to targeted subsets of existing and/or prospective customers determined as a result of proactively initiated filtered searches of homeowners' Home Health Records 126. As with FIG. 4A, while this process 400b is described below in the context of insurance providers, these concepts are equally applicable to other types of providers.

Steps 401b and 403b are equivalent to their counterparts from FIG. 4A (steps 401a and 403a), which determine the systemic score components and store them, along with initial values in homeowners' Home Health Records 126. Similarly, steps 405b and 410b are equivalent to their counterparts from FIG. 4A (steps 405a and 410a), during which VFM Server 110 processes each homeowner's raw sensor data, recalculates the ROL Score and stores it, along with modified ROL Factor values, in Home Health Record 126.

At this point, whether or not each insurance provider also receives ROL Alerts, each insurance provider may proactively offer personalized insurance services to selected subsets of existing and/or prospective customers. As discussed in greater detail below with respect to particular scenarios, each insurance provider may proactively submit a filtered search of homeowner Home Health Records 126 for the purpose of identifying a desired subset of homeowners to which particular personalized insurance services will be offered.

In step 420b, VFM Server 110 receives and performs the filtered search submitted by each insurance provider, and returns the results of that search (i.e., the extracted targeted subset of homeowners) to that insurance provider. These search results enable each insurance provider not only to determine the targeted subset of homeowners that will receive the offer, but also to further personalize the offer to some or all of such homeowners, as discussed above.

Upon receiving each such offer, in step 440b, VFM Server 110 proceeds to implement each such offer, in step 450b, with respect to the designated targeted subset of homeowners, and, in step 460b, to implement any follow-on personalized provider services with respect to homeowners that accepted such offers, after which processing returns to step 405a. Steps 440b, 450b and 460b are equivalent to their counterparts from FIG. 4A (steps 440a, 450a and 460a), with respect to the implementation of initial and follow-on personalized insurance services.

Following are various scenarios illustrating many of the key concepts of the present invention described above. Many other scenarios will be apparent to those skilled in the art without departing from the spirit of the present invention.

### Scenario #1 AC Unit Problem

In this first scenario, VFM system 100 generates an initial alert indicating that an air conditioning unit (AC unit) is “working too hard” in that It is not achieving its thermostat setting within an expected period of time (based on its operational model). It's power is continuous, yet temperature readings over time are not rising sufficiently to reach the thermostat setting.

The recommended action corresponding to this alert is that the homeowner close a door to a particular room that is a suspected cause of this problem. A door sensor enabled VFM system 100 to be aware that this particular door had been left open for an extended period of time.

Upon performing this action, no more alerts are generated for awhile, and the action appears to have solved the problem. In other words, the AC unit is reaching its temperature set point as expected (within a reasonable tolerance).

After some time has passed (e.g., a few days or weeks), VFM system 100 generates a second alert indicating that the AC unit is making an unusual noise (e.g., based upon a nearby sound sensor). The corresponding action instructs the homeowner to check for a visible obstruction (e.g., a tree limb that may have fallen next to the unit).

Upon checking the AC unit, the homeowner finds no visible obstruction, but confirms that the noise is still present. Shortly thereafter, VFM system 100 issues a third alert equivalent to the initial alert regarding the AC unit working too hard.

In this case, however, VFM system 100 is aware that the door remained closed. Yet, other sensors in proximity to the AC unit (e.g., intake/outtake temperature sensors and pressure sensors) indicate that the freon level of the AC unit is low. So a corresponding action (now part of the 3^{rd} related alert-action pair) recommends that coolant (freon) be added.

If the homeowner is capable, VFM system 100 would be configured to instruct the homeowner to add the coolant. Otherwise, a service call is scheduled (with or without the homeowner's approval, depending upon a predetermined configuration option). In any event, the action is completed and the coolant is added. For some period of time thereafter, no further alerts are generated, at least tentatively indicating that the problem has been resolved.

However, many months later, VFM system 100 generates the same alert as the initial alert, indicating that the AC unit is working too hard. Knowing that the coolant had been filled within the past year, VFM system 100 suspects a freon leak and generates an action recommending a service call. A service technician proactively contacts the homeowner via VFM system 100 and schedules the service call.

Because the service technician has been informed of this entire service history over time, the service call is relatively quick, efficient and inexpensive. The freon leak is found and repaired relatively quickly. No further alerts relating to the AC unit are generated for many years, and the problem appears to have been resolved.

At this point, the homeowner has avoided multiple service calls due to proactive alerts and recommended corresponding actions that not only resolved minor symptoms along the way, but eventually resulted in a diagnosis and resolution of a potentially more significant underlying problem (freon leak). Once VFM system 100 diagnosed this problem, it addressed the problem with a single, relatively inexpensive service call (due to the proactive related alert-action pairs generated by VFM system 100 over time, as well as the summary of the AC unit's service history delivered to the service technician over time).

Many years later, however, another alert is generated indicating that the AC unit is again working too hard, and that its power consumption is abnormally high. The corresponding recommended action is to replace the air filters (i.e., preventive maintenance), which the homeowner is capable of doing.

Yet, a short time (e.g., a few days) later, another alert is generated indicating a relatively loud noise and another potential freon leak. The corresponding recommended action at this point is to replace the AC unit with a new more energy efficient model (after recognizing that the expense of what it suspects will be a major repair is not justified, and that the homeowner's User Goals prioritize energy efficiency and reliability over short-term expenses).

### Scenario #2 Systemic (System-Wide and Whole-Home) Issues

In this scenario, multiple pieces of equipment are involved, and the homeowner's premises are located in a hot and humid area with relatively extreme weather conditions. The homeowner installs both an AC unit and a dehumidifier which work together to provide a more comfortable cooling environment in the premises, despite the area's hot and humid weather.

Years after the units have been working fine, VFM system 100 generates an alert indicating that the AC unit is working too hard (e.g., because it is 110 degrees Fahrenheit outside, and the AC unit is set to achieve 68 degrees). The corresponding recommended action is to raise the thermostat to 71 degrees (on the assumption that such a temperature will still provide sufficient comfort).

VFM system 100 automatically raises the thermostat to 71 degrees, after notifying the homeowner and receiving permission in accordance with the predefined configuration covering such scenarios. Over a relatively short period of time, however, the outside temperature increased to 115 degrees and VFM system 100 generated the same alert indicating that the AC unit was working too hard.

In this case, the corresponding recommended action was for the homeowner to close the dampers in rooms having relatively low occupancy (determined based upon arrays of strategically placed motion sensors) and to ensure the doors to such rooms remained closed. Nevertheless, VFM system 100 soon generated a third alert, in this case indicating that the dehumidifier was working too hard (evidenced, for example, by a long runtime to reduce the relative humidity below 70 degrees).

Based on an analysis of the operation of these interdependent units over time, VFM system 100 generates a corresponding recommended action of adding a second dehumidifier. In other words, VFM system 100 determined that the hot and humid environment was not being sufficiently addressed by the AC unit and single dehumidifier.

It also recognized that a larger AC unit, or a second AC unit, was far less cost effective than adding a second dehumidifier, which as a system with the AC unit was projected to provide sufficient cooling and comfort. The homeowner purchased the second dehumidifier and received no alerts for many years, effectively solving the problem.

After quite a few years, however, VFM system 100 generated an alert indicating that the AC unit was running inefficiently, and noting that its age indicated that it was nearing the end of its life. The corresponding recommended action was to purchase a new smaller but far more efficient AC unit that would integrate well with the 2 dehumidifiers (a cost-effective solution).

Moreover, the recommended action further suggested adding a heat exchanger and ceiling fans in specified bedrooms to complement the new smaller AC unit. As a result, the homeowner extended the life not only of the original AC unit, but of the larger system itself, which now included the new smaller AC unit, two dehumidifiers, a heat exchanger (to remove excess heat from the premises and heat the pool) and ceiling fans in specified bedrooms.

### Scenario #3 Insurance Provider—Crawl Space Humidity

Insurance providers have recognized that a key element to reducing ROL is the modernization of existing homes by weatherizing and electrifying them. Weatherization is a process for protecting a home and its interior from the elements (sunlight, precipitation, wind, etc.). It typically involves assessing the home's thermal condition and identifying and implementing cost effective modifications to reduce energy consumption and optimize energy efficiency. Electrification is a process for transitioning a home's energy sources from fossil fuels (e.g., natural gas) to electricity. This may include electric heating, induction cooktops, electric fireplaces, efficient LED lighting, etc.

In this scenario, insurance providers focus on a common problem frequently found in the crawl spaces underneath the floors of many homes—humidity. Excess humidity can result in mold and mildew, insulation damage, rotting wood and water damage, which can lead not only to damaged infrastructure and equipment, but also to serious health concerns.

These humidity-related concerns are typically addressed by controlling the source of humidity from the ground and air coming into the crawl space. As a starting point in this scenario, one or more insurance providers seek to offer a crawl space inspection, to be followed up with suggestion maintenance and other action items. Such an inspection could be offered for free or at a discount, as a means of incentivizing targeted homeowners to accept the inspection offer.

However, without the benefit of a Homecare Network of connected providers, such as insurance providers 140, and the continuous visibility into homeowner behavior afforded by VFM system 100, insurance providers would be unable to offer personalized insurance services, such as the crawl space inspection offer, to a desired subset of existing and prospective customers.

In one embodiment of this scenario, illustrated in FIG. 4A above, an insurance provider receives over time a number of ROL Alerts from various homeowners, along with actionable context indicating the existence of excess crawl space humidity. It should be noted that such indications may be direct (e.g., based on humidity or water sensor readings in a crawl space) or indirect (e.g., based on a reported odor in one of the rooms of a home), and may indicate different levels of severity.

In any event, as a result of receiving many such ROL Alerts over time, an insurance provider can compile a list of likely beneficiaries of its crawl space inspection offer. Moreover, insurance providers can perform additional searches of such homeowners' Home Health Records 126 to further refine and personalize its offer to particular groups of existing and prospective customers. For example, homeowners with more severe potential problems may receive greater discounts on the offer, as more follow-on work may be more likely. Similarly, groups of homeowners without any equipment or sensors in their crawl spaces may also receive relatively greater discounts.

In another embodiment of this scenario, illustrated in FIG. 4B above, an insurance provider proactively searches homeowners' Home Health Records 126 for key indicators (including ROL Factors) of humidity-related concerns in crawl spaces. Relevant indicators include age and income, health conditions, geography and climate (e.g., Alabama has higher relative humidity than California), as well as many other factors considered relevant by a particular insurance provider. Here too, the types and severity of such potential problems afford insurance providers with the ability to personalize their offer to desired existing and prospective customers.

Still other embodiments involve hybrid combinations of ROL Alerts and filtered searches to identify a desired subset of homeowners to which insurance providers may target their offer. By combining “passive” information obtained via ROL Alerts with proactive filtered searches of homeowners' Home Health Records 126 (enabled by the Homecare Network), insurance providers can leverage a great deal of information that facilitates the targeting of personalized insurance services to desired subsets of existing and prospective customers.

It should be noted that various static and dynamic factors facilitate an insurance provider's identification of relevant groups of homeowners. For example, static factors include the existence of certain crawl space equipment (which might affect the likelihood of a leak), the type of floors (e.g., wood floors may be more prone to water damage than stone floors), the cost of the home, among others. Dynamic factors include persistent extreme humidity (obtained, for example, via humidity sensors) that may indicate a likelihood of corrosion (particularly where copper pipes are present), extreme changes in water usage, repair and other service history, and various other indicators of potential humidity-related problems.

However this subset of targeted homeowners is identified, an insurance provider can transmit these personalized offers via the Homecare Network to VFM Server 110, which directs such offers to the targeted homeowners. Upon being notified by VFM Server 110 (via the Homecare Network) of which homeowners have accepted the various offers (as these offers may vary among different groups of homeowners), an insurance provider arranges for the personalized crawl space inspections.

In one embodiment, each insurance provider has its own “network” of inspectors. In other embodiments, certain insurance providers obtain the assistance of other providers (e.g., specialized crawl space inspectors) via the Homecare Network.

Upon completing each inspection, different personalized follow-on actions are offered to each homeowner based on the results of the inspection. For example, different levels of ground coverings (such as thin or thick layers of plastic) may be appropriate for particular homeowners. Others may be offered plastic wall coverings and fully sealed crawl space air intakes. In more extreme cases, french drains around the house may be appropriate.

Other recommended actions involve the addition of equipment in the crawl space, such as a dehumidifier and sump pump. Moreover, temperature, water and humidity sensors may be offered at discounted prices depending upon each homeowner's existing conditions and the severity of potential problems revealed by the inspection. Such sensors offer further visibility into future conditions (e.g., presence of a small leak, failure of a dehumidifier, inefficient motors, persistent high humidity, etc.).

In one embodiment, insurance providers offer maintenance services to minimize the risk of ongoing crawl space humidity-related problems over time. For example, such services include changing filters and cleaning coils on dehumidifiers, ensuring proper orientation of equipment (which can change over time, particularly if used frequently) and other standard maintenance of equipment (including sensors) to ensure proper operation. Certain maintenance services can be performed via remote monitoring, while others require physical on-site visits.

Over time, the benefits of these personalized insurance services will become apparent to the different categories of homeowners who accepted the crawl space inspection offer, as well as follow-on service offers. For example, early detection of a potential leak not only saves the homeowner money, but also reduces their ROL, which indirectly benefits their insurance provider. Homeowners further benefit from lower energy bills and improved health outcomes (e.g., decreased hospitalizations from long-term effects of mold, as well as reduced occurrences or worsening of conditions such as asthma), prevention of severe water damage from unnoticed leaks and an overall improvement of their ROL Score.

Insurance providers benefit by limiting the risk profile of their existing customers, as well as targeting relatively low-risk prospective customers. The ability to target personalized insurance services by proximity to particular geographic areas facilitates broader overall geographic coverage. In short, insurance providers can, to some extent, “choose their customers.”

Moreover, beyond the individual insurance providers and homeowners, this scenario illustrates various societal benefits. Improved health outcomes benefit society in many indirect ways, such as reducing the impact on scarce social services. Lenders experience fewer defaults and utility companies obtain significant amounts of data that enable them to load-balance their services more efficiently.

Before turning to different scenarios, it should be emphasized, as noted above, that this scenario (and other analogous scenarios) can be implemented in both an alert-driven (e.g., via ROL Alerts) and proactive search-driven (e.g., via filtered searches of homeowners' Home Health Records 126) manner. Moreover, different personalized insurance services may be offered to homeowners from multiple different insurance providers (via the Homecare Network), reflecting competition that benefits homeowners through lower prices and higher-quality services. Finally, by enabling insurance providers to distinguish themselves (e.g., by customizing ROL Factors and ROL Functions, including ROL Alert thresholds), competition is further enhanced, benefitting homeowners and providers alike.

### Scenario #4 Insurance Provider—Water Heater Maintenance

In this scenario, insurance providers focus on another common problem—deferred maintenance (in this case, regarding hot water heaters). Overall, hot water heaters experience a relatively high cost of operation, particularly when not properly maintained. Absent annual “flushing” of the heater, as well as annual on-site inspections to reveal common problems, the cost of operation may increase dramatically. Moreover, pollution and the development of mold may result, particularly from gas water heaters. Sediment at the bottom of hot water heaters can lead to corrosion of pipes and eventual water leaks. Finally, it is far more difficult to conserve energy by “time-shifting” the operation of gas heaters, as opposed to their electric counterparts.

In this scenario, one or more insurance providers seek to offer a discounted hot water heater maintenance service, along with a credit toward replacement should that prove necessary. In other embodiments, this hot water heater maintenance service could be offered for free, or with other features to incentivize homeowners to accept the offer.

As was the case with the crawl space inspection offer discussed above, various means of identifying a targeted subset of existing and prospective customers are employed. By utilizing a combination of the alert-driven (per FIG. 4A) and proactive filtered-search-driven (per FIG. 4B) approaches, as discussed above, insurance providers can determine who should receive their hot water heater maintenance service offer.

For example, relevant factors include (among many others) the type, size and age of a homeowner's existing hot water heater, as well as its location (e.g., in an attic), prior service calls, maintenance record, number and frequency of high temperature and humidity readings, home value, etc.

Whether factors such as these are identified from actionable context associated with ROL Alerts, from proactive filtered searches of homeowners' Home Health Records 126, or from a combination thereof, an insurance provider transmits its personalized hot water heater maintenance service offers via the Homecare Network to VFM Server 110, which directs such offers to the targeted subset of homeowners. Upon being notified by VFM Server 110 (via the Homecare Network) of which homeowners have accepted the various offers, an insurance provider arranges for the personalized hot water heater maintenance services.

As was the case with the crawl space inspection offers discussed above, certain follow-on actions are recommended depending upon the results of the hot water heater maintenance services. For example, those homeowners without a “sensor overlay” may be offered a set of sensors in proximity of their hot water heater (leak sensors, temperature and humidity sensors, power sensors, etc).

Other follow-on service offers include annual or other ongoing maintenance services, such as flushing the hot water heater or adding a drain pan. Additional monitoring services include an operating cost analysis (whether for a gas hot water heater or an electric hot water heater), based on various sensor data over time. Still other services include changes in an automated operating schedule, such as running at different times or different temperatures based on other real-time sensor data.

Replacement offers are also recommended for those homeowners whose current hot water heater is in sufficiently bad condition, as well as for homeowners who desire to improve energy efficiency or achieve related environmental goals (e.g., by replacing a gas hot water heater with an electric hot water heater or similar equipment). In some embodiments, replacement offers may be offered over a period of time (e.g., some number of months or years, along with modified operating suggestions to prolong the life of the hot water heater or conserve energy in the interim).

Here too, the benefits of such personalized insurance services will become apparent to the different categories of homeowners who accepted the hot water heater maintenance service offer, as well as follow-on service offers. For example, hot water heaters are particularly susceptible to water leaks over time. Early detection of such leaks not only saves homeowners money, but also reduces their ROL. Expanding monitoring, as well as periodic maintenance, also lowers ROL and saves homeowners money over time.

Here too, insurance providers benefit by limiting the risk profile of their existing customers, as well as targeting relatively low-risk prospective customers. They also broaden their overall geographic coverage by targeting their personalized insurance services by proximity to particular geographic areas. They also, to some extent, “choose their customers.”

Similar societal benefits also result in this scenario. Preventing significant leaks and water damages inherently reduces the impact on scarce social services. Here too, lenders experience fewer defaults and utility companies obtain significant amounts of data that enable them to load-balance their services more efficiently.

### Scenario #5 Filtered Search Premium Reduction to Low/High Risk Users

Finally, we turn to an even more insurance-specific scenario in which one or more insurance providers proactively seek to focus on relative low-risk and high-risk existing and prospective customers. Existing and prospective customers with relatively low ROL Scores are offered reduced or below-market premiums, while higher-risk existing and prospective customers are offered discounted incentives designed to lower their ROL (e.g., incentives to install “smart home upgrades consisting of leak and temperature sensors, water shut-off valves, security systems, smoke detectors and professional monitoring services).

In this scenario, insurance providers initiate proactive filtered searches of homeowners' Home Health Records 126 via the Homecare Network of VFM system 100. For example, factors such as age, location and “engagement” (responding to alerts and suggested actions), among others, are employed to gauge a likelihood of retention—i.e., homeowners who are unlikely to change insurance providers.

Upon identifying two key subsets of existing and prospective homeowners to receive personalized insurance services: (1) relatively low-ROL homeowners who will receive low or reduced premium offers, and (2) relatively high-ROL homeowners who will receive discounted smart-home upgrade offers, an insurance provider submits each of these offers (for its respective subset of existing and prospective customers) to VFM system 100 via the Homecare Network.

Upon being notified by VFM Server 110 (via the Homecare Network) of which homeowners have accepted the various offers, the insurance provider arranges for the personalized premium reduction and smart-home upgrade services to be implemented for their respective subsets of existing and prospective homeowners.

Existing low-ROL customers benefit by virtue of being incentivized to maintain their low ROL and thus their reduced premiums. Should their ROL Score increase significantly over time, such premium reductions may disappear (in accordance with the specified terms of the offer). Prospective low-ROL customers benefit from below-market insurance premiums, while the insurance provider benefits from effectively choosing new lower-risk customers (a group they were able to identify due to the Homecare Network and the visibility it offers even to prospective insurance providers). As a result, insurance providers compete for these “valued” customers.

Similarly, existing high-ROL customers benefit from discounted services designed to improve their ROL Scores and make them “better customers.” Such homeowners can benefit by reducing their ROL Scores over time (saving money by proactively avoiding expensive repairs, increasing their energy efficiency, etc.), while insurance providers benefit by reducing the risk in their portfolio. Here too, societal benefits result from fewer defaults and reduced use of scarce social services.

Prospective high-ROL customers also benefit from discounted services designed to improve their ROL Scores and make them “better prospective customers.” Insurance providers benefit by obtaining new customers whose premiums are more accurately tied to their improving ROL Score, with potential premium reductions over time. Insurance providers are effectively choosing their customers by transforming “bad customers” into good ones (while maintaining a much closer customer relationship due to the improved visibility offered by VFM system 100).

1. A system that maintains the health of the equipment and infrastructure of one or more properties, the system comprising the following:
(a) a data monitor that receives dynamic data reflecting changes over time in the state of the equipment and infrastructure of the one or more properties;
(b) a home health record comprising a set of static and dynamic information reflecting the state of one or more components of the equipment and infrastructure of the one or more properties, wherein the home health record includes dynamic data received from the data monitor over time; and
(c) a provider network manager that manages communications with a provider network, the provider network comprising a plurality of connected providers with expertise relevant to the equipment and infrastructure of the one or more properties;
(d) wherein the system enables the plurality of connected providers (i) to identify a targeted subset of system users who occupy the one or more properties, and (ii) to offer one or more personalized provider services to that targeted subset of system users, in an effort to improve the health of the equipment and infrastructure of the one or more properties.

2. The system of claim 1, wherein the system enables the plurality of connected providers to initiate searches of the home health records of the system users in order to facilitate the identification of the targeted subsets of system users.

3. The system of claim 1, further comprising a scoring engine that continuously calculates systemic scores reflecting the systemic state of the one or more properties, wherein the systemic scores are stored in the home health record and are calculated as a function of the static and dynamic information stored in the home health record, and wherein the systemic scores facilitate the identification of the targeted subsets of system users by the plurality of connected providers.

4. The system of claim 3, wherein the system enables the plurality of connected providers to customize the function used by the system to calculate the systemic scores.
